(19) United States
(12) Patent Application Publication
(10) Pub. No.: US 2024/0042395 A1
(43) Pub. Date: Feb. 8, 2024

(54) PATTERNED POROUS MATERIAL SURFACES

(71) Applicant: Donaldson Company, Inc., Bloomington, MN (US)

(72) Inventors: Mikayla A. Yoder, Eagan, MN (US); Davis B. Moravec, Burnsville, MN (US); Christopher P. Conklin, Columbia, MD (US); Matthew P. Goertz, Bloomington, MN (US); Stephen K. Sontag, Plymouth, MN (US); Anil Suthar, Eden Prairie, MN (US); Stuti S. Rajgarhia, Woodbury, MN (US); Alexandra M. Boyat, Minneapolis, MN (US); Andrew J. Dallas, Lakeville, MN (US)

(21) Appl. No.: 18/266,496

(22) PCT Filed: Apr. 1, 2022
(86) PCT No.: PCT/US2022/023143

§ 371 Date: Jun. 9, 2023

Related U.S. Application Data
(60) Provisional application No. 63/170,104, filed on Apr. 2, 2021.

(51) Int. Cl. B01D 71/36; B01D 67/00

(52) U.S. Cl. CPC B01D 71/36; B01D 67/0088; B01D 2325/08; B01D 2325/0283

(57) ABSTRACT

A filter media comprises a layer of porous material having a patterned outer surface comprising a plurality of structures. Each structure in the plurality has at least a predetermined height based on an expected contaminant and spacing between each structure in a pair of structures in the plurality is at most a predetermined spacing based on the expected contaminant.

### RELATED APPLICATIONS

This application claims the benefit of U.S. Provisional Application No. 63/170,104, filed 2 Apr. 2021, the disclosure of which is incorporated by reference herein in its entirety.

### TECHNICAL FIELD

This disclosure relates generally to patterned surfaces of porous materials to increase the hydrophobicity and/or oleophobicity of the materials and methods of forming the same.

### BACKGROUND

Many enclosures require venting to an external atmosphere to release waste gas or to relieve a pressure differential. Venting may be necessary as a result of temperature fluctuations, altitude changes, and vapor pressure of contained liquids. Vents, or venting media, equalize pressure by allowing gas to flow through while repelling liquids and solids to protect internal components. However, in certain uses (e.g., automotive, medical, construction) venting media or filter media is exposed to liquid contaminants having low surface tensions and/or high viscosities that do not easily release from porous venting media. These contaminants then plug the media pores and reduce, or redirect, the escaping air flow. While certain coatings have been used to improve the hydrophobicity and/or oleophobicity of venting media, physical modifications to the venting material surface may provide improved release of low surface tension and/or high viscosity contaminants alone, or in combination with coatings.

### SUMMARY

Embodiments described herein are directed to a filter media comprising a layer of porous material having a patterned outer surface. The patterned outer surface comprises a plurality of pillars, wherein each pillar in the plurality has at least a predetermined height based on an expected contaminant and spacing between each pillar in a pair of pillars in the plurality is at most a predetermined spacing based on the expected contaminant.

Other embodiments are directed to a filter media comprising a layer of porous material having a patterned outer surface comprising a plurality of raised structures. Each raised structure in the plurality has at least a predetermined height based on an expected contaminant and spacing between each raised structure in a pair of raised structures in the plurality is at most a predetermined spacing based on the expected contaminant.

Other embodiments are directed to a filter media comprising a first layer of porous material and a second layer of material disposed on the first layer. The second layer has a patterned outer surface comprising a plurality of raised structures, and each raised structure in the plurality has at least a predetermined height based on an expected contaminant and spacing between each raised structure in a pair of raised structures in the plurality is at most a predetermined spacing based on the expected contaminant.

Other embodiments are directed to a filter media comprising a layer of porous material having a hierarchical structure and a patterned outer surface comprising a plurality of raised structures. Each raised structure in the plurality has at least a predetermined height based on an expected contaminant and spacing between each raised structure in a pair of raised structures in the plurality is at most a predetermined spacing based on the expected contaminant.

Other embodiments are directed to a venting apparatus comprising an opening configured to vent an enclosure and a venting element affixed within the venting apparatus and forming a liquid-tight, gas-permeable seal of the opening. The venting element comprises porous material having a patterned surface comprising a plurality of raised structures, wherein each raised structure in the plurality has at least a predetermined height based on an expected contaminant and spacing between each raised structure in a pair of raised structures in the plurality is at most a predetermined spacing based on the expected contaminant.

Further embodiments are directed to a method comprising providing a layer of porous material and providing a stamp having a patterned outer surface that corresponds to a negative of a pattern comprising a plurality of raised structures. Each raised structure in the plurality has at least a predetermined height based on an expected contaminant and spacing between each raised structure in a pair of raised structures in the plurality is at most a predetermined spacing based on the expected contaminant. The method further includes applying the stamp to a first surface of the layer of porous material at a predetermined temperature and pressure to form the pattern of the plurality of raised structures having the predetermined height and spacing on the first surface of the layer of porous material.

The above summary is not intended to describe each disclosed embodiment or every implementation of the present disclosure. The figures and the detailed description below more particularly exemplify illustrative embodiments.

### BRIEF DESCRIPTION OF THE DRAWINGS

The discussion below refers to the following figures, wherein the same reference number may be used to identify the similar/same component in multiple figures. However, the use of a number to refer to a component in a given figure is not intended to limit the component in another figure labeled with the same number. The figures are not necessarily to scale.

FIG. 1A is an illustration of a droplet on a patterned surface in the Wenzel state;

FIG. 1B is an illustration of a droplet on a patterned surface in the Cassie-Baxter state;

FIG. 2 is an illustration of a roll-off angle for a droplet on a patterned surface;

FIG. 3A is a cross-sectional view of a patterned surface in accordance with certain embodiments;

FIG. 3B is a top-down view of a patterned surface in accordance with certain embodiments;

FIG. 3C is a top-down view of a patterned surface with square-shaped structures in accordance with certain embodiments;

FIG. 3D is a top-down view of a patterned surface with hexagon-shaped structures in accordance with certain embodiments;

FIG. 3E is a top-down view of a patterned surface in accordance with certain embodiments;

FIG. 3F is a diagram illustrating contact line force in accordance with certain embodiments;

FIG. 4A is an illustration of a patterned surface having a pattern solid fraction of about 0.25 in accordance with certain embodiments;

FIG. 4B is an illustration of a patterned surface having a pattern solid fraction of about 0.5 in accordance with certain embodiments;

FIG. 5A is a graph of contact angle as a function of a surface pattern solid fraction in accordance with certain embodiments;

FIG. 5B is an image of a droplet on an unpatterned surface of porous material;

FIG. 5C is an image of a droplet on a patterned surface of porous material in accordance with certain embodiments;

FIG. 6 is an image of a material having a hierarchical structure in accordance with certain embodiments;

FIG. 7 is a graph of contact angles as a function of surface tension of unpatterned and patterned materials in accordance with certain embodiments;

FIG. 8A is a graph of permeability as a function of contaminant on unpatterned and patterned materials in accordance with certain embodiments;

FIG. 8B is an image of contaminant on an unpatterned material;

FIG. 8C is an image of the contaminant of FIG. 8B on the patterned material of FIG. 8B;

FIG. 9A is an image of a patterned surface of rib-shaped structures in accordance with certain embodiments;

FIG. 9B is the measured profile of the patterned surface of FIG. 9A;

FIG. 10 is a graph of roll-off angle as a function of pattern height in accordance with certain embodiments;

FIG. 11 is a graph of roll-off angle as a function of surface tension for differently-spaced patterns in accordance with certain embodiments;

FIG. 12 is a graph of roll-off angle as a function of surface tension for a first porous material in accordance with certain embodiments;

FIG. 13A is a graph of loss of permeability as a function of pressure for a low-porosity material in accordance with certain embodiments;

FIG. 13B is a graph of loss of permeability as a function of pressure for a high-porosity material in accordance with certain embodiments;

FIGS. 14A-B are sectional views of composite patterned materials in accordance with certain embodiments;

FIG. 15 is a flow diagram of a method for forming a patterned porous material surface in accordance with certain embodiments;

FIGS. 16A-B illustrate methods for forming a patterned porous material surface in accordance with certain embodiments; and

FIG. 17 is a cross-sectional view of a porous material with a coating on a patterned surface in accordance with certain embodiments.

FIG. 18 is a schematic cross-sectional side view of a vented article according to an embodiment.

FIG. 19 is a schematic cross-sectional side view of a vented battery pack according to an embodiment.

FIGS. 20A-20C are schematic cross-sectional side views of parts of vented packages according to an embodiment.

FIGS. 21A-21C are schematic cross-sectional detail views of parts of vented packages according to an embodiment.

FIGS. 22A and 22B are microscopic images of materials produced in Example 5.

FIG. 23A is a microscopic image of a material produced in Example 6.

FIG. 23B is a schematic depiction of the material of FIG. 23A.

FIG. 23C is a cross-sectional view of the material of FIG. 23B.

FIG. 24 is a microscopic image of a material produced in Example 7.

FIG. 25 is a microscopic image of a comparative material in Example 7.

FIG. 26 is a microscopic image of a material produced in Example 8.

FIG. 27 is graph of the permeability results in Example 9.

### DEFINITIONS

All headings provided herein are for the convenience of the reader and should not be used to limit the meaning of any text that follows the heading, unless so specified.

Terms such as “a,” “an,” and “the” are not intended to refer to only a singular entity, but include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

As used here, the term “or” is generally employed in its usual sense including “and/or” unless the content clearly dictates otherwise. The term “and/or” (if used) means one or all of the listed elements or a combination of any two or more of the listed elements. Further, “e.g.” is used as an abbreviation for the Latin phrase exempli gratia and means “for example.”

The use of numerical ranges by endpoints includes all numbers within that range (e.g., 1 to 5 includes 1, 1.5, 2, 2.75, 3, 3.80, 4, and 5) and any range within that range. Moreover, unless otherwise indicated, all numbers expressing quantities, and all terms expressing direction/orientation (e.g., vertical, horizontal, parallel, perpendicular, etc.) in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The term “about” is used here in conjunction with numeric values to include normal variations in measurements as expected by persons skilled in the art, and is understood have the same meaning as “approximately” and to cover a typical margin of error, such as ±5% of the stated value.

Relative terms such as proximal, distal, left, right, forward, rearward, top, bottom, side, upper, lower, horizontal, vertical, and the like may be used in this disclosure to simplify the description. However, such relative terms do not limit the scope of the invention in any way. Terms such as left, right, forward, rearward, top, bottom, side, upper, lower, horizontal, vertical, and the like are from the perspective observed in the particular figure.

Any direction referred to herein, such as “top,” “bottom,” “left,” “right,” “upper,” “lower,” and other directions or orientations are described herein for clarity and brevity but are not intended to be limiting of an actual device or system. Devices and systems described herein may be used in a number of directions and orientations.

As used here, “have,” “having,” “include,” “including,” “comprise,” “comprising,” or the like are used in their open-ended sense, and generally mean “including, but not limited to.” It will be understood that “consisting essentially of,” “consisting of,” and the like are subsumed in “comprising” and the like. As used herein, “consisting essentially of,” as it relates to a composition, product, method, or the like, means that the components of the composition, product, method, or the like are limited to the enumerated components and any other components that do not materially affect the basic and novel characteristic(s) of the composition, product, method, or the like.

The words “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure, including the claims.

The term “substantially” as used here has the same meaning as “significantly,” and can be understood to modify the term that follows by at least about 90%, at least about 95%, or at least about 98%. The term “not substantially” as used here has the same meaning as “not significantly,” and can be understood to have the inverse meaning of “substantially,” i.e., modifying the term that follows by not more than 10%, not more than 5%, or not more than 2%.

### DETAILED DESCRIPTION

The present disclosure relates to filtration media and venting media that is capable of resisting fouling by repelling and releasing liquid contaminants that come into contact with the media. The media includes porous material with a patterned surface. The patterned surface has a plurality of raised structures disposed on the surface.

The terms filter media and venting media are used here interchangeably, and the term “venting media” may simply refer to filter media that is being used to provide venting.

Raised pattern features or structures on surfaces alter the properties of the surface in a variety of ways. For example, raised surface patterns can alter omniphobic surface properties (e.g., hydrophobicity, oleophobicity, etc.), adhesion (increased or decreased), anti-fouling behavior, and designed roll-off behavior of droplets. Forming raised surface patterns in venting media or filter media can increase the hydrophobicity and/or oleophobicity to improve release properties for liquid contaminants, including those having a surface tension less than or equal to 72 mN/m. When the patterning is also combined with a coating (e.g., of small chain fluoropolymers), high oleophobicity can be achieved without the use of bio-persistent chemicals such as longer chain perfluoroalkyl substances (PFAS).

Patterned filter media with, or without, a coating may improve performance and longevity in various venting applications such as integrated venting modules for gas turbine systems, medical devices, packaging, batteries, and power train systems. These environments, and others, expose filter media to potential liquid contaminants that are difficult to release from the filter media surface. When the contaminant droplets do not release, or do not release cleanly (e.g., leave a residual trail), the contaminant clogs pores in the filter media and blocks or redirects gas flow reducing the performance and longevity of the venting media or filter media. Structured patterns can be designed to improve the hydrophobicity and/or oleophobicity of a venting media or filter media with respect to an expected contaminant by controlling the height and spacing of the structures.

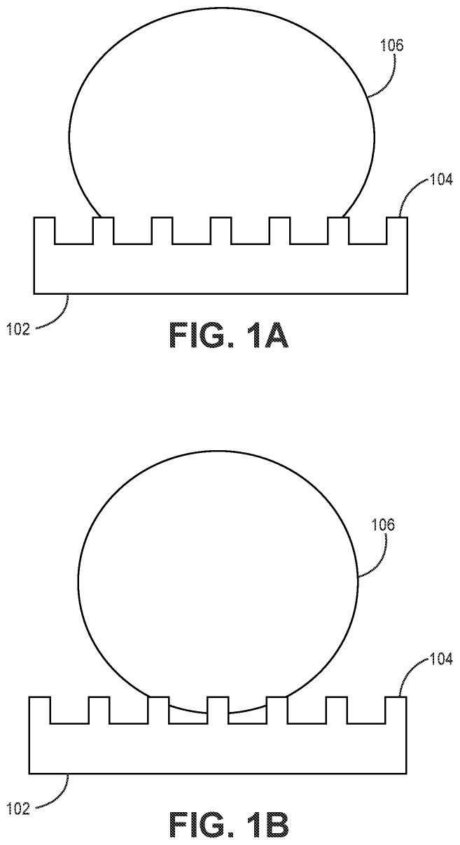

FIGS. 1A and 1B illustrate different droplet states for hydrophobic and/or oleophobic materials having a patterned surface. In FIG. 1A, the droplet 106 penetrates the microstructures 104 to such that the droplet 106 reaches the surface of the material 102. This state is known as a Wenzel state and can be described as cos θ*=r cos θ, where θ* represents the apparent contact angle between the droplet 106 and the surface of the raised structures 104, θ is the equilibrium contact angle on a smooth surface, and r represents the roughness of the surface. The contact angle is the angle measured through a liquid droplet where a liquid-vapor interface meets a solid surface. Hydrophobic and oleophobic materials are defined as materials with a contact angle greater than 90°, and superhydrophobic materials have a contact angle greater than 150°. The equilibrium contact angle can be estimated from Young's equation. In a Wenzel state, the increased contact angle is attributed to the increased surface area of the textured/structured surface.

In FIG. 1B, the droplet 106 remains at the surface of the raised structures 104 and does not penetrate to the surface of the material 102. Rather, the droplet 106 forms a meniscus, or a plurality of menisci, between two or more raised structures 104 leaving pockets of air between the droplet 106 and the surface of the raised structures. This state is known as a Cassie-Baxter state and can be described as cos θ*=ϕₛ(1+cos θ)−1, where θ* represents the apparent contact angle between the droplet 106 and the surface of the raised structures 104, θ is the equilibrium contact angle on a smooth surface, and ϕₛ is the solid fraction of the surface. For a material to be gas permeable but liquid impermeable, a material may be designed with a patterned surface to obtain a Cassie-Baxter state for expected liquids (e.g., contaminants) contacting the material.

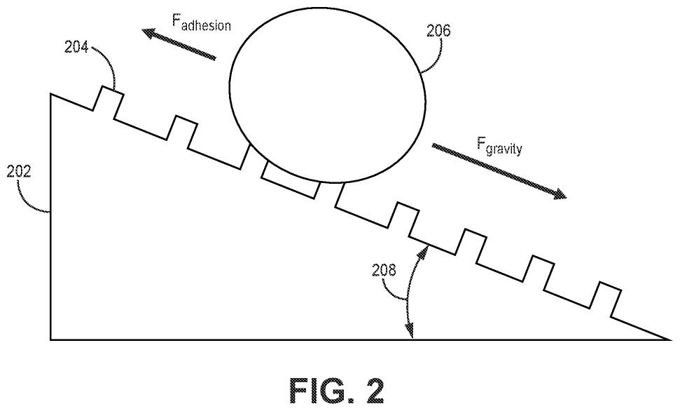

In addition to the Cassie-Baxter state, the patterned surface of porous materials may be designed to provide a roll-off angle that facilitates release of liquids on the surface. The concept of a roll-off angle is illustrated in FIG. 2. The roll-off angle is the tilt angle at which a substrate, such as a patterned porous material, is disposed so that a droplet (e.g., a droplet of contaminant) releases and rolls off the substrate. As shown, this can be understood as the angle 208 at which a substrate 202 with a patterned surface 204 is tilted so that the force of adhesion acting on the droplet material 206 is less than the force of gravity. Thus, the roll-off angle can be considered a measurement of adhesion to a substrate by a liquid contaminant and correlates with the ability of the substrate to avoid clogging by repelling liquid contaminants such as oils. Roll-off angle is measured by using a droplet size of at least 5 μL at a tilt speed of 2° per second. Here, roll-off angles are given for a droplet size of 20 μL unless otherwise indicated. A lower roll-off angle indicates improved repellency. When droplets do not roll off, the porous material can be clogged or plugged and gas permeability of the material may be reduced. In certain instances, a droplet may roll off, but leave material behind which can also reduce the gas permeability of the material. On the other hand, a clean release of droplets at lower angles may increase the functionality and lifetime of a porous material used as a venting material. As discussed further below, roll-off angles for porous materials can be decreased with patterned surfaces designed with predetermined parameters.

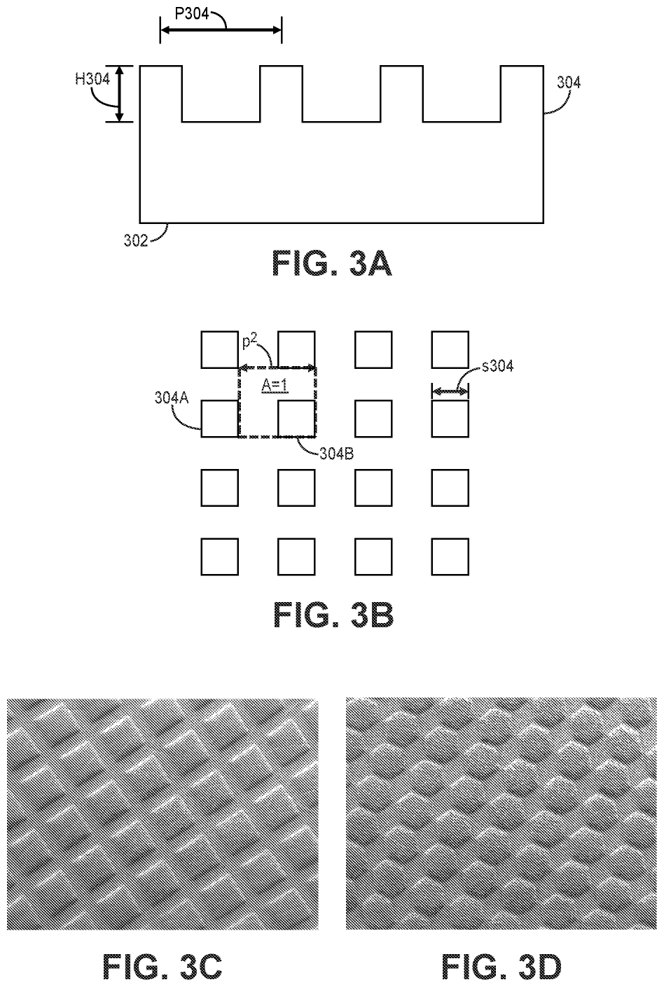

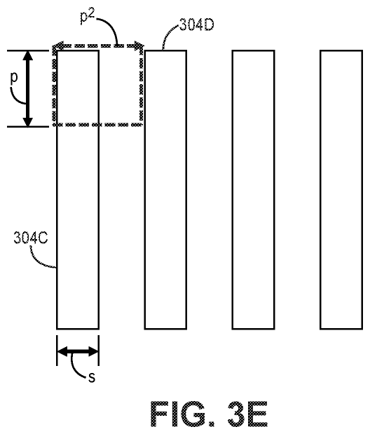

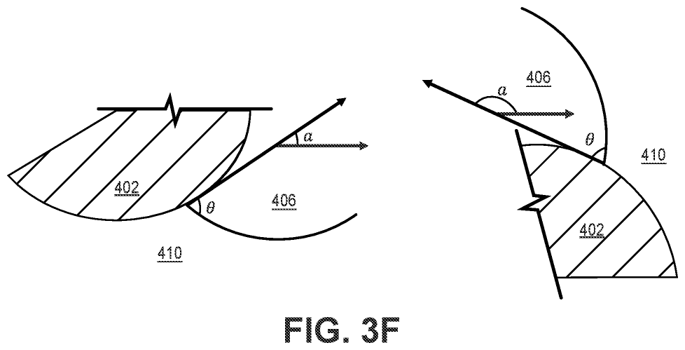

Dimensions of patterned surfaces are described in connection with FIGS. 3A-3F. FIG. 3A illustrates the dimensions of a patterned surface, such as that of a porous material. Example porous materials that may be patterned as described herein include woven materials, nonwoven materials (e.g., wet-laid), electrospun fiber mats, membranes including polypropylene, polyethylene, polyester, polysulfone, polyethersulfone, expanded polytetrafluoroethylene, polyvinylidene fluoride, polyamide (Nylon), polyacrylonitrile, polycarbonate, or cellulose acetate, and the like. While the dimensions of the structures may range upward from 300 nm, the structures discussed herein generally may have dimensions (e.g., width) in the range of 0.5 μm to 500 μm. The material 302 has a plurality of structures 304 formed on at least one surface. The structures 304 have a height H304 and can be any variety of shapes. For example, the structures may take the shape of pillars having a cross-sectional shape of a square, circle, or a polygon, ribs having a rectangular or square cross-sectional shape, or splines of finite width, and combinations thereof. The structures also have a pitch p304, which is the center-to-center spacing between two adjacent structures. The height and/or pitch may be substantially uniform among a plurality of raised structures, or one or both may vary.

The plurality of raised structures may form a pattern on the material's surface. An example pattern is shown in FIG. 3B, including a first structure 304A and an adjacent structure 304B. While the illustrated pattern is a 4×4 array of square shaped structures with consistent pitch, a pattern could involve different shapes, a plurality of shapes, varying pitches and/or an unequal number of structures in the rows and/or columns. In alternative embodiments, patterns may take complex shapes which include complex combinations of the above-discussed structures. The pattern shapes may be regular or irregular. Because the illustrated pattern involves square-shaped structures at a consistent pitch, the disposition factor A (the number of raised structures per unit surface area) is one, and the unit surface area is p². The raised structures 304 have a width s304. The height h304 and the pitch p304, in some cases referred to generally as spacing, for the pattern structures have been shown to affect the roll-off angle, and they can be tailored for an expected contaminant material.

The minimum height to achieve the desired roll-off angle for an expected contaminant may be calculated by Equation 1:

$$h = \frac{{p}^{2}}{AL} ( \frac{1 - ϕ}{cos {θ}_{unpatterned}} - ϕ + 1 ) , \qquad Equation 1$$

where h is the minimum height, L is the perimeter of a structure, p is pitch of the pattern, A is the number of structures per unit surface area, ϕ is the pattern solid fraction of the patterned surface, and θ_{unpatterned} is the contact angle on an unpatterned layer of an otherwise identical porous material to the one being patterned. Herein, the phrase “otherwise identical” refers to the same material having the same thickness, porosity, mean pore size, chemical composition, and basis weight prior to patterning (e.g., before compression). For example, for the square structures of the embodiment of FIG. 3B, the perimeter L is equivalent to 4×s304 (four times the width of the structure). The pattern solid fraction for the square shaped structures of FIG. 3B is determined with Equation 2:

$$ϕ = \frac{{Area}_{structure}}{{p}^{2}} = \frac{{s}^{2}}{{p}^{2}} . \qquad Equation 2$$

In embodiments where the structures are lines as illustrated in FIG. 3E, L is the perimeter of the rectangle within p² (as shown in FIG. 3E, 2s+2p), and the pattern solid fraction would be

$$ϕ = \frac{{Area}_{structure}}{{p}^{2}} = \frac{sp}{{p}^{2}} = \frac{s}{p}$$

since the structure is defined as being within p² for calculation purposes. Although the pitch in FIG. 3E is shown as measured from a left edge of a first structure 304C to the left edge of an adjacent structure 304D, the measurement is consistent with the distance from the center of structure 304C to the center of structure 304D.

The height provided by Equation 1 is the minimum height to achieve the desired roll-off angle. However, one or more structures in the pattern may have heights that exceed the calculated value. According to an embodiment, all or substantially all structures in the pattern have a height that meets or exceeds the calculated value. In certain embodiments, a pattern may include raised structures of multiple predetermined heights. For example, a first portion of a plurality of raised structures may have a first height and a second portion of the plurality of raised structures may have a second height. However, in a preferred embodiment, each of the predetermined heights would meet or exceed the predetermined height calculated using Equation 1.

According to an embodiment, the porous material has a patterned surface with a plurality of raised structures. The raised structures have a height of 1 μm or greater, 3 μm or greater, 5 μm or greater, 8 μm or greater, 10 μm or greater, 12 μm or greater, or 15 μm or 30 greater. The raised structures have a height of 50 μm or less, 45 μm or less, 40 μm or less, 35 μm or less, 30 μm or less, 25 μm or less, 20 μm or less, 15 μm or less, 12 μm or less, or 10 μm or less. The range of suitable heights for the raised structures may be selected based on one or more contaminants that the material will be exposed to during an intended use. For example, if the material will be exposed to contaminants having a surface tension in the range of 25 mN/m to 80 mN/m (or, for example, in the rage of 25 mN/m to 30 mN/m), the raised structures may have a height from 2 μm to 40 μm, from 4 μm to 30 μm, from 5 μm to 20 μm, or from 6 μm to 15 μm. In some such cases, the raised structures may have a height below 12 μm.

When the raised structures are formed by imprinting, the raised structures are formed by compressing material around the raised structures. Thus, when forming the raised structures on a porous media through imprinting, raised structures with smaller heights correlate to less compression of the media. In such cases, smaller heights may be preferable to maintain the porous material's permeability properties. Examples of such structure heights include about 1 μm to 30 μm, 1 μm to 15 μm, and 1 μm to 10 μm.

The maximum pitch for achieving the desired repellency and roll-off angle for a structure may be calculated using Equation 3:

$${P}_{wet} = \frac{{F}_{CL}}{A} , \qquad Equation 3$$

where P_{wet} is the wetting pressure into the plurality of raised structures, F_{CL} is the contact line force, and A is the projected surface area of a meniscus between a plurality of raised structures. According to an embodiment, two or more raised structures in the pattern may have spacings less than the calculated value.

The contact line force F_{CL} is defined as the vertical component of the contact line force, as described by Equation 4:

F_{CL}=γ_{LG}l sin(θ_{unpatterned}−α) Equation 4

where γ_{LG} is the surface tension between the liquid and gas, l is the length of the contact line, and α is the angle the solid boundary makes with the horizontal plane. The contact line is a continuous line at the interface of the liquid (e.g., droplet 406), the solid surface (e.g., surface of the material 402), and the surrounding environment (e.g., air 410). When the forces affecting the liquid are at equilibrium, the contact line is pinned to the surface at a set of pinning points. At equilibrium, the contact line can be thought of as a continuous line that connects the pinning points along the perimeter of a droplet. The vertical component of the contact line force is further illustrated in FIG. 3F.

In addition, when designing a pattern for achieving the desired repellency and roll-off angle, the width of the raised structures in the pattern may be determined by the Cassie-Baxter equation, shown below as Equation 5:

cos θ*=ϕₛ(1+cos θ)−1, Equation 5

where θ* represents the apparent contact angle between a droplet and the surface of the structures and ϕₛ is the pattern solid fraction of the patterned surface. Using these equations to predetermine and design a pattern's structure height and spacing provides control over the roll-off angle of a material with respect to an expected contaminant.

According to an embodiment, the porous material having a patterned surface with a plurality of raised structures exhibits a desired contact angle when contacted with a liquid contaminant. The contact angle of the patterned surface may be higher than the contact angle of the same material without a pattern. The contact angle of the patterned surface may be at least 5° higher, at least 15° higher, at least 20° higher, or at least 25° higher than the same material without a pattern. There may not be a desired upper limit on the improvement in contact angle, and the contact angle may be up to 180°. In some embodiments, the porous material having a patterned surface with a plurality of raised structures exhibits superphobicity toward a contaminant, exhibiting a contact angle of 150° or greater. Such materials may be superhydrophobic or superoleophobic. Contact angle may be measured using any known technique. For example, contact angles may be measured using a contact angle meter, such as the one discussed in Example 1.

According to an embodiment, the porous material having a patterned surface with a plurality of raised structures exhibits a desired receding contact angle when contacted with a liquid contaminant. The receding contact angle of the patterned surface may be higher than the receding contact angle of the same material without a pattern. The receding contact angle of the patterned surface may be 50° or greater, 60° or greater, 70° or greater, 80° or greater, or 90° or greater. There may not be a desired upper limit on the improvement in the receding contact angle, and the receding contact angle may be up to 180°. Receding contact angle may be measured using any known technique. For example, receding contact angles may be measured using a contact angle meter, such as the one discussed in Example 1.

According to an embodiment, the porous material having a patterned surface with a plurality of raised structures exhibits a desired roll-off angle when contacted with a liquid contaminant. The roll-off angle may be 75° or less, 60° or less, 40° or less, 30° or less, or 20° or less. The lowest possible roll-off angle may be desired for efficient release of a contaminant. In practice, however, the roll-off angle may be 1° or more, 2° or more, or 5° or more. The roll-off angle may be in a range of 2° to 45°, 5° to 35°, or 5° to 20°. Roll-off angle may be measured using a contact angle meter, such as the one discussed in Example 1.

FIG. 3C is an image of an array of square structures and FIG. 3D is an image of an array of hexagonal structures on a porous material. As may be seen in FIGS. 3C and 3D, the size of the respective structures and pitch of the respective patterns varies the ratio of raised surface area of the pattern as compared with the overall patterned area.

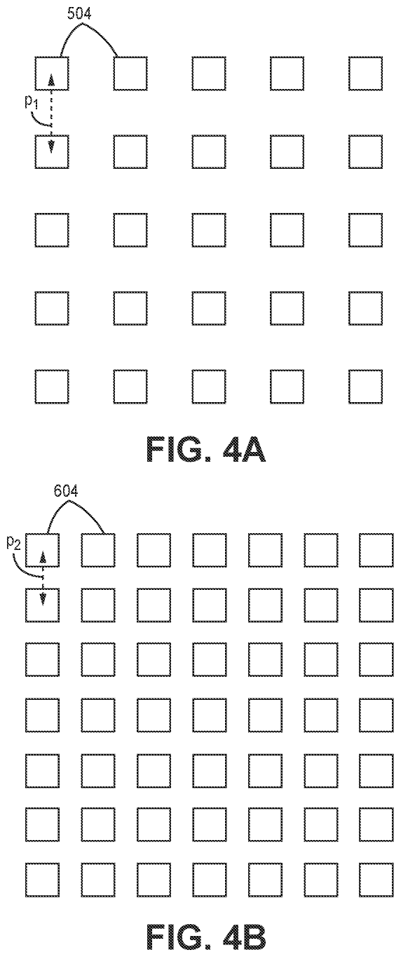

FIGS. 4A and 4B illustrate the difference in pattern solid fraction between two raised structure arrays having different pattern pitch. Pattern solid fraction is defined as the ratio of the projected surface area of a structure with respect to the unit area of the pattern on the material. For example, Equation 2 above provides the calculation of pattern solid fraction for a pattern with square structures. The total area of the arrays and the size of the structures in FIGS. 4A and 4B are the same, but the pitch of the structures differs. The larger pitch p1 in FIG. 4A results in fewer structures 504 per area, providing a pattern solid fraction of about 0.25. The smaller pitch p2 in FIG. 4B results in more structures 604 per the same total area, providing a higher pattern solid fraction of about 0.5. The pattern solid fraction of a raised pattern on a porous material has been shown to affect the contact angle of droplets on that material.

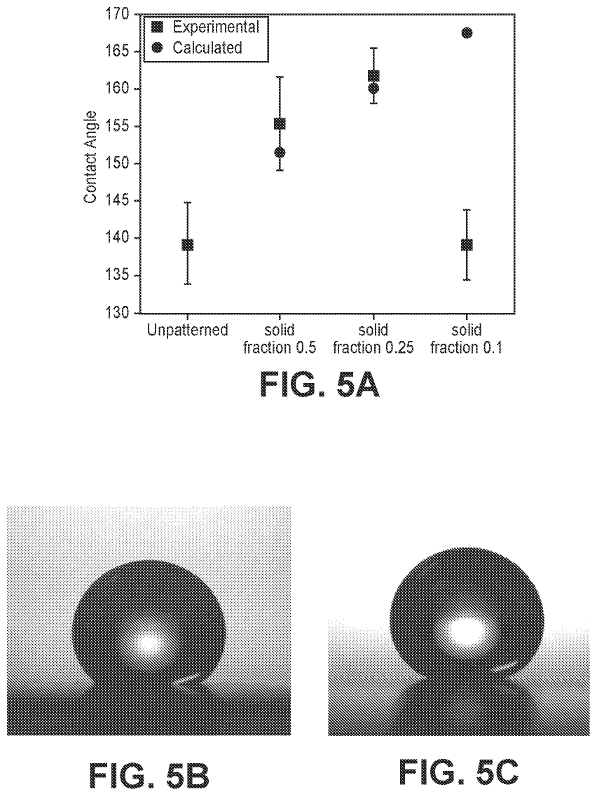

FIG. 5A is a chart showing calculated and experimental contact angles as a function of the pattern solid fraction of a porous material substrate. The chart shows that the experimental contact angles are predictable based on the Cassie-Baxter equation discussed above. The contact angle is the angle measured through a liquid droplet where a liquid-vapor interface meets a solid surface. Hydrophobic and oleophobic materials are defined as materials with a contact angle greater than 90°, and superhydrophobic materials have a contact angle greater than 150°. As may be seen, the unpatterned material and the material with a pattern solid fraction of 0.1 have lower contact angles. But, forming a pattern solid fraction of 0.5 and 0.25 provided a contact angle in the range of superhydrophobicity.

The results of FIG. 5A are consistent with calculated changes in contact angles using the Cassie-Baxter equation above. Table 1 shows the predicted change in contact angle between an unpatterned material and the same material after formation of a raised structured pattern as described herein. The pattern has square-shaped structures (s=25 μm) and the pitch between them (p) varies thereby varying the pattern solid fraction (ϕₛ). As seen in Table 1 below, a pattern solid fraction of 0.1 gives the highest contact angle; however, the pitch (p) may exceed the dimensions calculated by Equation 3 and the liquid wets through the raised structures. In this case, it is likely that the droplet is not in a Cassie state and the roll-off angle and release of contaminant will not be enhanced as compared to an unpatterned material. This is observed in FIG. 5A for a pattern solid fraction of 0.1 where a decrease in contact angle is observed as compared to the other solid fraction patterns.

TABLE 1

| Pattern Solid | | Calculated | Observed |
|---|---|---|---|
| Fraction (Øₛ) | p (pitch, μm) | Contact Angle (°) | Contact Angle (°) |
| 0.1 | 54 | 167 | 139.2 |
| 0.25 | 25 | 160 | 161.7 |
| 0.5 | 10.4 | 152 | 155.3 |
| Unpatterned | — | 140 | 139.3 |

The raised structures have a cross-sectional dimension (e.g., width) and a distance from adjacent raised structures (pitch). The raised structures may provide the patterned outer surface with a pattern solid fraction. The pattern solid fraction is the ratio of the area covered by the raised structures to the total area of the layer, e.g., as calculated by Equation 2. In some embodiments, the pattern solid fraction is greater than 0.1. The pattern solid fraction may be 0.15 or greater, 0.2 or greater, 0.25 or greater, 0.3 or greater, 0.4 or greater, or 0.5 or greater. The pattern solid fraction may be 0.9 or less, 0.8 or less, 0.75 or less, 0.7 or less, or 0.6 or less. In certain embodiments, the pattern solid fraction is from 0.1 to 0.8, from 0.2 to 0.75, or from 0.25 to 0.75.

According to an embodiment, a layer of porous material has a patterned outer surface with a plurality of raised structures disposed on the outer surface. The raised structures may be formed by any suitable method, including imprinting, etching, singeing, casting, phase-inversion micromolding, and the like. The raised structures may be in an ordered pattern and have a pitch (center to center distance) of 1 μm or greater, 2 μm or greater, 5 μm or greater, 10 μm or greater, 20 μm or greater, 50 μm or greater, or 100 μm or greater. The raised structures may have a pitch of 200 μm or less, 150 μm or less, 100 μm or less, 75 μm or less, 50 μm or less, 40 μm or less, or 25 μm or less. The raised structures may have a pitch of 1 μm to 100 μm or from 5 μm to 50 μm.

The raised structures may have a width of 0.5 μm or greater, 1 μm or greater, 2 μm or greater, 5 μm or greater, or 10 μm or greater. The raised structures may have a width of 60 μm or less, 40 μm or less, 30 μm or less, 20 μm or less, 10 μm or less, 5 μm or less, 2 μm or less, or 1 μm or less.

The effect of the patterning of a material on the contact angle can be seen in FIGS. 5B and 5C. In FIG. 5B a droplet is shown on an unpatterned material, and in FIG. 5C a droplet of the same size and material is shown on a patterned material. The droplet of FIG. 5C is more spherical in shape due to the pattern in comparison to that of FIG. 5B, providing a higher contact angle.

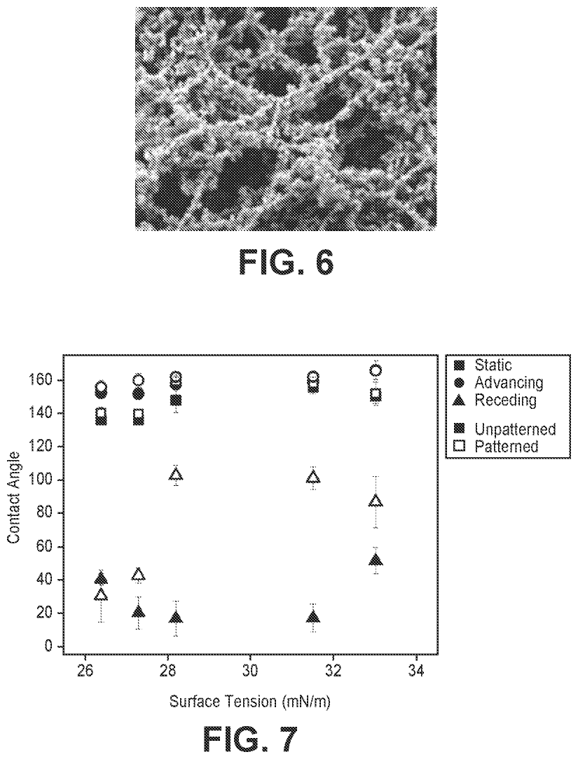

Another way to control the contact angle is by using a material with a hierarchical structure. These materials have a solid fraction on the surface that is very low (e.g., less than 0.25), providing improved roll-off and release properties. An example of a material with a hierarchical structure, made of cellulose acetate, is shown in the image of FIG. 6. The material is a phase-inverted cellulose acetate membrane having nanometer-scale spheres, or nodules, on micrometer-scale fibers. The smaller structures of the hierarchical structure increase the wetting pressure of a liquid by creating a petal state, and the larger fibers may provide support and/or maintain overall higher air flow for the material. The two size regimes have their own breakthrough pressures, where the nanoscale nodules have a higher breakthrough pressure than the microfiber pores. Due to this difference in breakthrough pressures, a petal state may occur, where the larger pores are wetted by the liquid while the smaller pores are not. Without being bound to theory, it is believed that the nanoscale nodules help reduce the solid fraction to reduce contact with the liquid.

According to an embodiment, a layer of porous material has an outer surface with a hierarchical pattern including a plurality of microscale features (e.g., nodules) and a plurality of raised macroscale features formed on the outer surface. The terms “microscale” and “macroscale” are used here to differentiate between features that differ in size by at least one order of magnitude, where microscale is understood to be smaller than macroscale. The terms “microscale” and “macroscale” are not necessarily indicative of any specific size range. The material may further include intermediate features sized between the microscale and macroscale features, or features that are smaller or larger than either of the microscale and macroscale features. In some cases, both the microscale features and the macroscale features are formed during the making of the porous material. In other cases, the microscale features are formed during the making of the porous material and the macroscale features are formed on (e.g., imprinted onto) the material after formation of the material. In some embodiments, the porous material itself has a hierarchical structure, and another layer of hierarchy is added to the porous material by forming the raised macroscale features. For example, cellulose acetate may have nodules that are sized about 50 nm to 1000 nm and pores that are sized about 0.2 μm to 20 μm (or even up to 50 μm in some cases), and the raised structures formed on the cellulose acetate may be up to 60 μm in size. Accordingly, in some embodiments, the layer of porous material having a patterned outer surface includes two or more distinct levels of hierarchy. In some embodiments, the layer of porous material having a patterned outer surface includes three levels of hierarchy.

As discussed above, when liquids do not release, or drain, off of a porous material, pores may be plugged by the liquid, causing air flow to be redirected. Release is defined as when the receding contact line (i.e., the back of a droplet) begins to move. An increase in the receding contact angle correlates with better release of the contaminant. Porous materials having a hierarchical structure have been shown to have low roll-off angles (e.g., less than 20°) for water-based contaminants when coated (e.g., with a fluoropolymer). However, when a material having a hierarchical structure is coated and patterned, the material shows very low roll-off angles (e.g., less than 10°) and high receding contact angles for many liquids (having differing surface tensions), including some oils. FIG. 7 is a chart showing the contact angle of liquids with various surface tensions as a function of surface tension for different contact angles (static, advancing, and receding) for patterned and unpatterned cellulose acetate. As can be seen, patterning of the material surface has a particularly great impact on the receding contact angle. This means that patterning may be particularly useful for effecting release and drainage of liquids off of porous materials.

The increase in receding contact angle indicates that for a patterned material, the liquid released cleanly, but for an unpatterned material, the droplet left behind a trail. The trail or residual film may also plug the pores of the material and reduce and/or redirect air flow. Without being bound to theory, it is believed that the increase in receding contact angle may be due to the reduction in solid fraction resulting from the patterning.

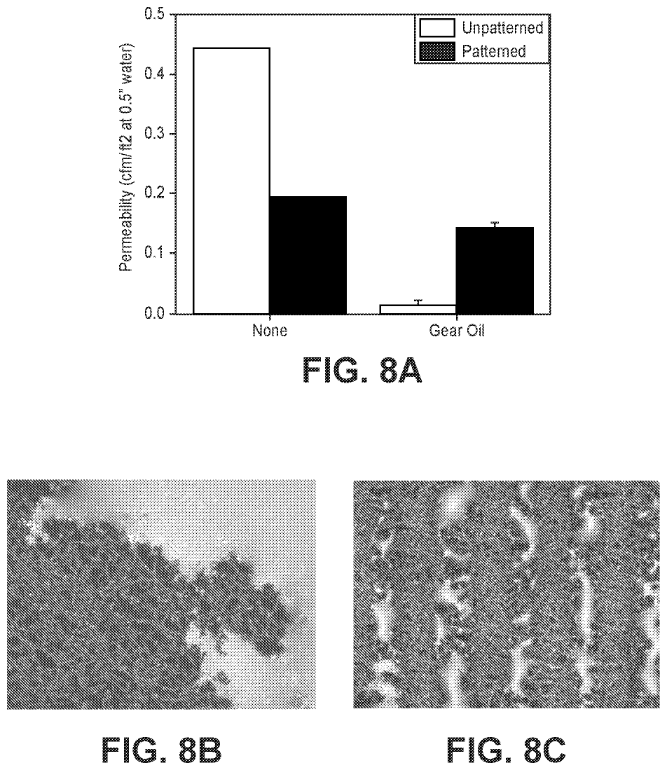

FIG. 8A is a chart showing the ability of a patterned and an unpatterned cellulose acetate substrate to recover permeability after contamination with gear oil. The chart shows that the patterned material maintains higher permeability after contamination. The unpatterned and patterned materials are shown, after contamination with gear oil, in FIGS. 8B and 8C, where FIG. 8C is the hierarchical material of FIG. 8B with a pattern applied. FIG. 8B shows the unpatterned membrane with a thick oil film over the surface, while FIG. 8C shows only a few oil droplets on the top of pattern structures. The positioning of the oil on top of the pattern in FIG. 8C indicates that a Cassie state was achieved with the pattern, which as discussed above, improves roll-off and release properties.

Hierarchical structures may be formed, for example, by a phase-inversion process or by another method, such as electrospinning fibers. For example, a hierarchical structure may be formed by including particles in the polymer solution during electrospinning. The structures could also be achieved with a coating whereby the hierarchical structure is introduced to a porous material in the coating, and need not be part of the underlying material. Further, a hierarchical structure and raised pattern may be formed by phase inversion micromolding. The process involves first casting a polymer solution (including a polymer dissolved in solvent) onto a patterned substrate and then submerging the cast polymer into a non-solvent bath or using vapor induced phase separation, completing the phase inversion process. When the polymer membrane is formed, it can be peeled off of the patterned substrate and an inverse pattern on the polymer membrane surface is retained. In addition to the presence of a pattern increasing the contact angle and corresponding hydrophobicity and/or oleophobicity, the pattern dimensions also have an effect.

While the equations set forth above are described as being used to determine dimensions for a pattern applied to an existing porous material, the same equations may be used to directly form the patterns onto the surface of a membrane during formation of the membrane. For example, a pore structure can be designed that is inherent to a phase inverted membrane that provides raised structures according to the equations set forth above without the use of a patterned substrate. Thus, the hierarchical structures (or other porous material) could be designed and formed to have a predetermined raised structure height and/or spacing when the material or coating is created. Techniques such as micromolding allow for patterning to be applied without diminishing permeability, and direct formation techniques reduce the number of steps/processes to arrive at a patterned substrate.

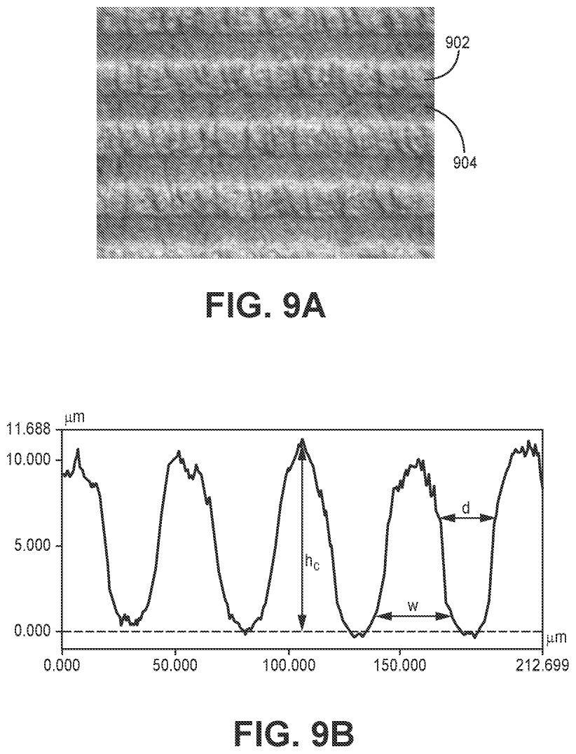

FIG. 9A is an image of a patterned porous material having predetermined structure heights and spacing in accordance with various embodiments described herein. The pattern includes raised lines 902 separated by spacing 904. The lines are about the same length and maintain a regular pitch throughout the pattern. FIG. 9B is the measured profile of the pattern of FIG. 9A. The height of the raised lines 902 is shown as arrow hc, the width of the raised lines 902 is shown as arrow w, and the spacing between the raised lines 902 is shown as arrow d. The raised lines 902 have a width of about 25 μm and the spacing between the raised lines 902 is about 25 μm. Controlling the height and spacing of structures for a pattern such as is shown in FIG. 9A, provides control over roll-off angle for an expected contaminant on a known porous material.

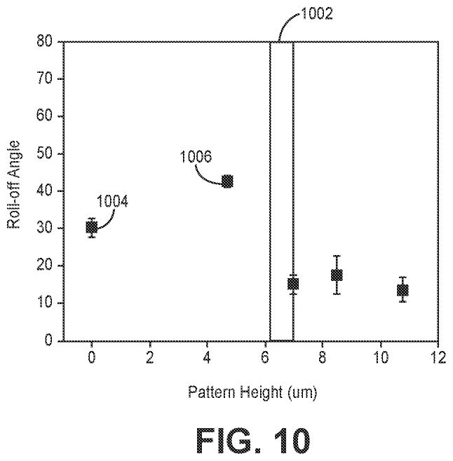

FIG. 10 is a chart showing roll-off angle as a function of the height of a raised pattern on a porous material. The shaded range 1002 illustrates the calculated predetermined height for the porous material and liquid contaminant as determined by Equation 1 above. As can be seen, each of the patterns having structure heights greater than the shaded range 1002 has a roll-off angle less than an unpatterned material 1004 and a material having a structure height less than the predetermined height 1006.

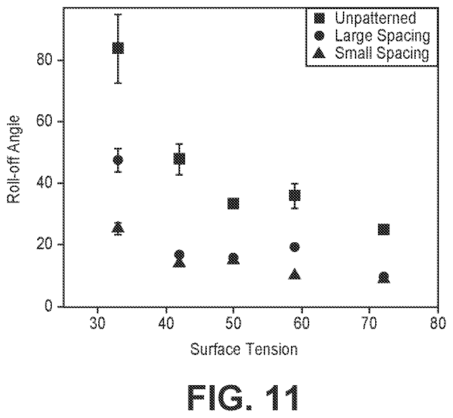

FIG. 11 is a chart showing roll-off angle of liquids with various surface tensions as a function of the surface tension for an unpatterned material as well as the same material with large (50 μm) and small (10 μm) pattern spacings. As can be seen, patterning the surface (regardless of spacing size) decreases the roll-off angle for liquids at all surface tensions. However, smaller pattern spacings decrease roll-off angles for low surface tension liquids. Thus, both the height and spacing of a pattern can be used to control a material roll-off angle.

The layer of porous material has a patterned outer surface with a plurality of raised structures may be made of any suitable material. Examples of materials that may be used to make the porous material include fibrous materials (e.g., woven filtration media, non-woven filtration media made from fibers, aligned electrospun fibers, etc.), membranes, aperture films, laminated films, and the like. Fibrous materials may include polymeric fibers, glass fibers, and metallic fibers. Examples of typical polymers used for filtration media include polypropylene, polyethylene, polyester, polysulfone, polyethersulfone, expanded polytetrafluoroethylene (“ePTFE”), polyvinylidene fluoride, polyamide (Nylon), polyacrylonitrile, polycarbonate, cellulose acetate, cellulose, and the like, and combinations thereof. Examples of typical polymers used for membranes include ePTFE, polypropylene, polyethylene, polyester, polysulfone, polyethersulfone, polyvinylidene fluoride, polyamide (Nylon), polyacrylonitrile, polycarbonate, cellulose acetate, and combinations thereof. The material may be selected based on the intended use of the porous patterned material and the method used to impart the pattern of raised structures onto the material. Various methods to impart the pattern of raised structures on the material include imprinting, etching, singeing, casting, phase-inversion micromolding, and the like. Imprinting may be particularly suitable for patterning thermoplastics and other compressible porous materials.

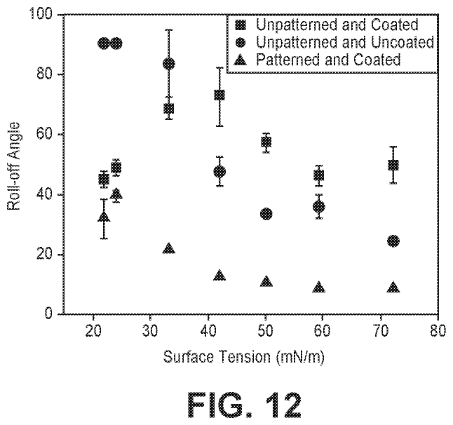

In addition to controlling the height and spacing of a raised pattern on a porous material, the material can be coated to further improve the roll-off angle. FIG. 12 is a chart showing roll-off angle of liquids with various surface tensions as a function of surface tension for a material that is unpatterned and uncoated, unpatterned and coated, and patterned and coated. It can be seen that patterning and coating the material reduces the roll-off angle for the same material across all surface tensions and particularly at surface tensions above 30 mN/m. Again, the patterned and coated material has a roll-off angle demonstrably lower than the unpatterned substrates at higher surface tensions, and the patterned material has comparable roll-off angles to the unpatterned substrates at lower surface tensions (<30 mN/m). At the two lowest surface tensions, the liquid wet through the unpatterned and uncoated material as demonstrated by the 90° roll-off angle, which indicates that the liquid did not roll off even when the material was held vertically. If the pattern spacing were reduced (i.e., increasing Pwet from Equation 3) the roll-off angle for these two data points at the lowest surface tensions for the patterned and coated material could also similarly be reduced.

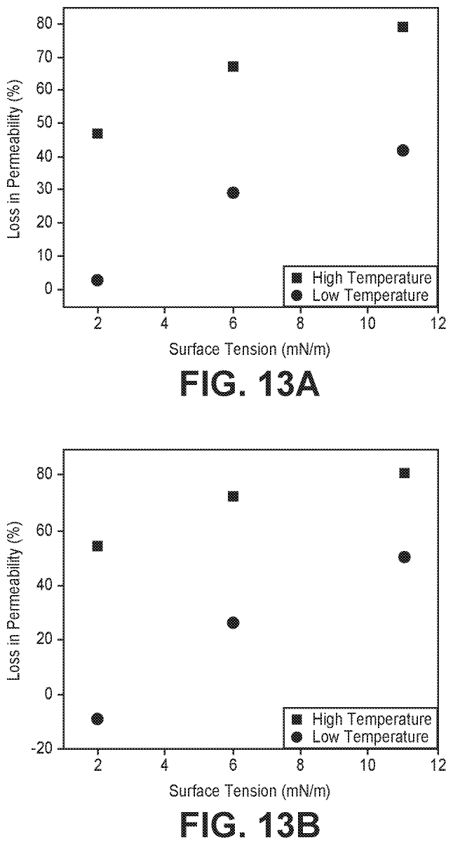

Patterning a porous material surface through imprinting may also reduce the permeability of the material due to compression at the surface. FIG. 13A is a chart showing the loss in permeability as a function of imprinting pressure for a low porosity material at low (room temperature) and high (100° C.) imprinting temperatures, and FIG. 13B is a chart of loss in permeability as a function of pressure for a high porosity material at low and high temperatures. The Frazier permeability of each membrane was measured, which measures the volume of air at a given pressure flowing through a given area of the porous material. Frazier permeability may be measured using known methods, such as ASTM D737-18. In this case, the measurement was conducted over a circular test are of 0.6 in². Frazier permeability is usually given in units of cfm/ft² at 0.5″ water pressure drop (1 cfm/ft² at 0.5″ water pressure drop is equivalent to 0.5 cm³/s/cm² at 125 Pa). Here, any Frazier permeability readings are given at 0.5″ water pressure drop. A high porosity material generally has a high Frazier permeability and a low porosity material generally has a low Frazier permeability. At high temperature formation of the patterns, the loss in permeability is fairly consistent for both low and high porosity materials. As might be expected, at low pressure and temperature formation, the loss in permeability is much smaller or negligible. However, the dimensions of the pattern that is formed change depending on pressure and temperature. In general, patterns with taller features may be formed by using a higher pressure and/or temperature. Therefore, the range of pressures and temperatures may be selected so as to obtain a pattern height above the calculated minimum height from Equation 1, without compromising significant permeability. For example, before a material is patterned, the material may have a pore size of at least about 0.05 μm and a Frazier permeability of 0.05 cfm/ft² at 0.5″ water pressure drop (0.025 cm³/s/cm² at 125 Pa) or greater. After compression, or patterning, the material may have a Frazier permeability of at least 0.05 cfm/ft² (0.025 cm³/s/cm² at 125 Pa). A patterned material as described herein has a permeability of at least 10%, or at least 30%, or at least 50% of a permeability of an otherwise identical non-patterned layer.

According to an embodiment, the porous material has a patterned outer surface with a plurality of raised structures disposed on the outer surface and exhibits a Frazier permeability of 0.1 cfm/ft² (0.051 cm³/s/cm² at 125 Pa) or greater, 0.2 cfm/ft² (0.10 cm³/s/cm² at 125 Pa) or greater, 0.4 cfm/ft² (0.20 cm³/s/cm² at 125 Pa) or greater, 0.5 cfm/ft² (0.25 cm³/s/cm² at 125 Pa) or greater, 0.6 cfm/ft² (0.30 cm³/s/cm² at 125 Pa) or greater, 0.7 cfm/ft² (0.36 cm³/s/cm² at 125 Pa) or greater, 0.8 cfm/ft² (0.41 cm³/s/cm² at 125 Pa) or greater, 0.9 cfm/ft² (0.46 cm^{3 /}s/cm² at 125 Pa) or greater, or 1 cfm/ft² (0.51 cm³/s/cm² at 125 Pa) or greater. While there is no desired upper limit on the permeability of the material, in practice, the Frazier permeability of the patterned material may be 3 cfm/ft² (1.52 cm³/s/cm² at 125 Pa) or lower, 2.5 cfm/ft² (1.27 cm³/s/cm² at 125 Pa) or lower, or 2 cfm/ft² (1.02 cm³/s/cm² at 125 Pa) or lower.

In certain embodiments, permeability loss may be mitigated or avoided with a composite patterned porous material. Composite materials may be multi-layer materials. The outer-most layer of the composite material may be patterned as described herein.

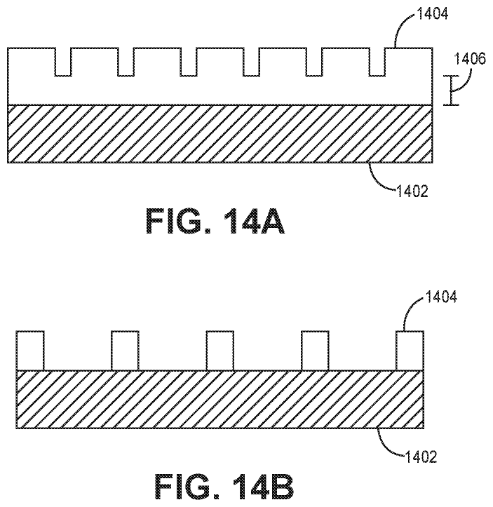

FIGS. 14A and 14B illustrate composite, or multi-layer, materials where a patterned layer is coupled with an underlying porous material layer. By providing the patterned layer to an underlying porous material layer, the patterned structures can be incorporated without losing permeability of the underlying porous material and the original specifications of the porous material with respect to permeability and water entry pressure can be maintained for a particular use.

In FIG. 14A, a first layer of porous material is provided 1402. A second layer of material 1404 is disposed on and/or coupled to the first layer to form a dual-layer composite material. A pattern is formed in the second layer to provide the advantages discussed herein with respect to low roll-off angles and improved release of contaminants. The pattern may be formed on the second layer prior to coupling the layers to form the composite material or after the first and second layer are affixed to each other. Alternatively, the pattern may be formed on the second layer after coupling of the layers. The first layer is a porous material that can be designed to satisfy air flow and water entry pressure specification needed for a desired use (e.g., venting) and could be used as-is, without modification. The second, structured layer is designed for one or more expected contaminants in the desired use to reduce the roll-off angle and increase receding contact angle (i.e., improve release). Without the second, patterned layer of material, the porous material may not readily release contaminants, which may result in liquid plugging the pores decreasing air flow. The second, patterned layer can also be a porous material, either the same material as the first layer, or a different type of porous material.

In certain embodiments, the second, patterned material may comprise at least one of polymeric fibers, metal meshes, expanded polytetrafluoroethylene (“ePTFE”), laser etched material, or another polymer material. The polymeric fibers can have any suitable shape or form, including cylinders, square fibers, or re-entrant cross-section.

The composite material can be formed by laminating the two material layers together or be combined any variety of ways. The pattern in the second layer may also be formed in a variety of ways. For example, FIG. 14A shows the second layer with an imprinted pattern including a residual thickness 1406 of the second layer between the bottom of the structures and the upper surface of the first layer. FIG. 14B shows alternative embodiments where the patterned, second layer does not include a residual thickness. The patterns of the embodiments of FIG. 14B may be formed through a variety of techniques including etching, singeing, depositing fibers, and stretching porous materials (e.g., to form aperture films).

The composite material may include any variety of combinations of materials. Suitable materials for the first layer include polypropylene, polyethylene, polyester, polysulfone, polyethersulfone, expanded polytetrafluoroethylene (“ePTFE”), polyvinylidene fluoride, polyamide (Nylon), polyacrylonitrile, polycarbonate, cellulose acetate, and combinations thereof. Suitable materials for the second layer include any suitable filter media, such as media prepared from polymeric fibers, metal meshes, expanded polytetrafluoroethylene (“ePTFE”), laser etched material, or another polymer material. The first and second layers may be prepare separately and combined (e.g., laminated) to form the composite material. Alternatively, the first or the second layer maybe prepared (e.g., cast) directly onto the other layer. The second (patterned) layer may be patterned before or after being combined with the first layer. In some embodiments, both layers include ePTFE but have different molecular weights (e.g., low and high molecular weight resins), where the low molecular weight resin does not expand as much as the high molecular weight resin is high enough so as not to break during expansion, to provide a unique pattern.

In certain embodiments, the second, patterned layer may be prepared from a material having increased pores/permeability (e.g., four times the desired permeability/pore size) to account for predicted loss of permeability after imprinting the pattern. Such a layer may be expanded polytetrafluoroethylene. The second layer may have a thickness of at least 20-30 μm. The second layer may be coupled with an unpatterned layer of expanded polytetrafluoroethylene.

In certain embodiments, the composite may comprise an asymmetric expanded polytetrafluoroethylene structure (e.g., having regions of the material with different properties, such as pore sizes, etc.). In some embodiments, one of the layers may be a stretched extrudate laminated onto an unstretched extrudate. The layers may then be further stretched together.

In some embodiments, the second layer includes a material having an open structure that has aligned (anisotropic) nodes to provide higher permeability.

According to an embodiment, the material of the second layer is compressible to enable imprinting of a raised pattern structure. The collapse of some of the pore structure may be compensated for by selecting a more open pore structure in the layer before patterning. Preferably, the material is not so compressible as to collapse the pore structure during imprinting, to avoid needing a very open initial pore structure prior to patterning. A material that generally has a high air flow and good compressibility could be patterned as the second layer. In certain embodiments, the second layer is prepared from a material with many nodes and fibrils. The nodes may be compressed to create the pattern of the second layer, yet avoiding loss of permeability by avoiding compressing the fibrils/pores. In further embodiments, the second layer is prepared from a uniaxially stretched expanded polytetrafluoroethylene, which may have a weaker structure than an underlying uniaxially stretched expanded polytetrafluoroethylene.

The pattern of the second layer is designed to provide desired roll-off angle and release properties for expected liquid contaminants as described herein. Both the material properties (including porosity and structure) and the pattern of the second layer, as well as the surface tension of the expected contaminant contribute to the design considerations. While the composite material is described as a dual layer material, the composite material may include more than two layers. The composite material may also include two or more patterned surfaces. In some embodiments, a porous material may be patterned on opposing surfaces either directly on one surface with a patterned material coupled to the other, or with two patterned layers coupled to both sides of the porous material.

Techniques for forming patterned surfaces are described below.

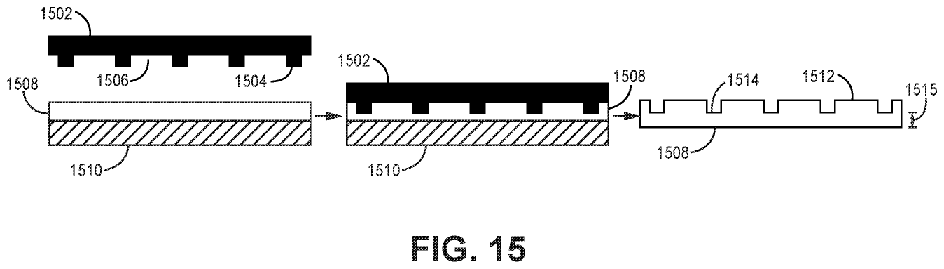

Turning to FIG. 15, a method for forming a patterned porous material, either directly on a material's outer surface or as a composite material as described above, is shown. A stamp 1502 is created, or provided, for imprinting a layer of porous material or a layer to be coupled with a layer of porous material. The stamp 1502 may be formed from a hard material (e.g., silicon wafer) patterned, e.g., via photolithography, to include one or more protruded areas 1504 and one or more gaps 1506 proximate or between the protruded areas 1504. The protruded areas 1504 and gaps 1506 form a negative pattern that corresponds to the desired pattern for the porous material. The desired pattern involves structures having at least a predetermined height and predetermined pitch or spacing as discussed above. Since the dimensions of the pattern structures are typically on a scale of nanometers or micrometers, the formation process may be referred to as nanoimprint lithography. On the stamp 1502, the gaps 1506 are shaped to correspond to the desired shape and desired height of the resulting structures 1512 in the porous material pattern, and the protruded areas 1504 form the spaces 1514 and define the spacing between the resulting structures. The layer of porous material 1508, or a layer of material to be patterned and coupled with a porous material, may be provided alone or on a support structure 1510 depending on the strength and other properties of the layer to be patterned 1508. The support structure 1510 may be formed of any materials that can withstand the imprinting environmental conditions. Examples of suitable support structure materials include polytetratluoroethylene, other fluoropolymers, silicone-based materials, or other inert materials that are not deformed at the imprinting temperatures.

The stamp 1502 is brought into contact with the surface of the material to be patterned 1508 by applying pressure and/or a temperature for a predetermined time. The pressure and/or temperature conditions may be determined based on the material being patterned as well as the desired pattern design. For example, the applied pressure may be 0.3 bar or greater, 2 bar or greater, 5 bar or greater, or 10 bar or greater. The applied pressure may be 50 bar or less, 40 bar or less, or 30 bar or less. In some embodiments, the applied pressure is in a range from 0.3 bar to 50 bar or from 5 bar to 40 bar. The applied temperature may be room temperature or greater, 30° C. or greater, 60° C. or greater, or 100° C. or greater. The applied temperature may be 250° C. or less, 200° C. or less, or 150° C. or less. The applied temperature may be in a range of 60° C. to 250° C. or from 100° C. to 200° C. When both temperature and pressure are applied, the temperature may be applied to the imprinting environment (e.g., in a heated chamber) or may be applied directly through the stamp 1502. The temperature and/or pressure may be applied for a predetermined time, for example, in a range of about 1 second and up to 10 minutes. When the stamp 1502 and patterned material 1508 are separated (e.g., after the temperature of the material has cooled down to at least below the Tg of the polymer, preferably lower than 40° C.), the surface of the resulting patterned material 1508 includes a pattern of structures 1512 having the predetermined height and predetermined spacing. The predetermined height is measured from the lowest point of the spaces 1514 between the structures to the outermost (highest) surface of the patterned layer. When the pattern is imprinted on the material, there may also be a residual thickness 1515 between the opposing surface of the material layer (i.e., the surface not patterned) and the lowest point of the pattern spacing.

The stamp 1502 may be used to imprint a predefined area of a layer's surface. If a larger pattern is desired, the stamp may be reapplied to other (contiguous or discrete) portions of the layer of material.

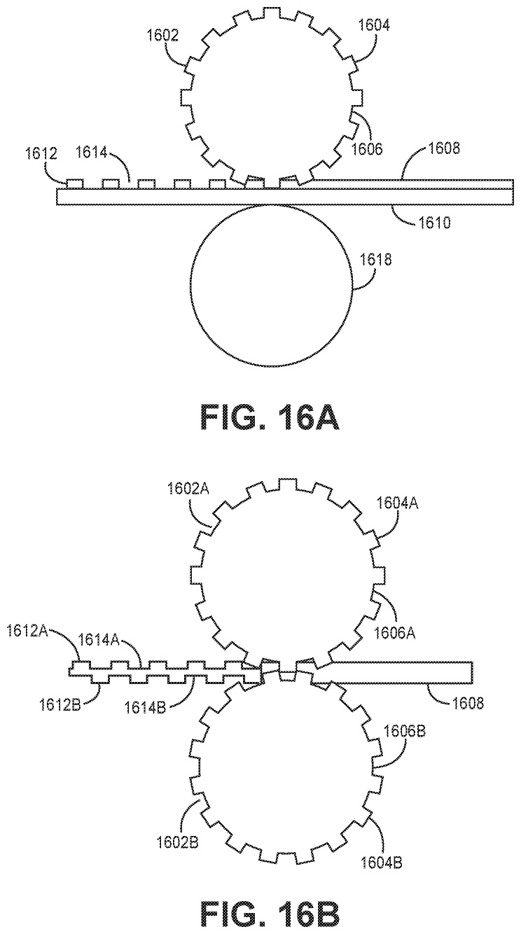

Alternative imprinting methods are shown in FIGS. 16A and 16B. In FIG. 16A, the stamp 1602 is in the form of an embossed roller or wheel. The embossed roller 1602 also includes one or more protruded areas 1604 and one or more gaps 1606 proximate or between the protruded areas 1604. The protruded areas 1604 and gaps 1606 again form a negative pattern that corresponds to the desired pattern for the material to be patterned 1608. The protruded areas 1604 and/or gaps 1606 may have uniform dimensions around the circumference of the embossed roller 1602 or one or more dimensions may be varied. The porous material or other material to be patterned 1608 is fed to the stamp substantially continuously, for example, in a roll-to-roll process. However, the speed at which the porous material is fed to the embossed roller 1602 may vary. Depending on the strength and other properties of the layer to be patterned 1608, the layer of material 1608 may be fed to the embossed roller 1602 on a support structure 1610 as discussed above. According to an alternative embodiment, the imprinting may be performed through roll-to-plate process.

When a single surface of the porous material 1608 is patterned, an unpatterned, hard roller 1618 may be provided opposite the embossed roller 1602 to control the imprinting conditions. For example, the distance between the unpatterned roller 1618 and the embossed roller 1602 can determine the pressure applied to the layer of material 1608 fed to the embossed roller 1602. Also, one or more of the unpatterned roller 1618, embossed roller 1602, or atmosphere (e.g., an enclosed, chamber environment) may be heated to apply temperature during the imprinting. Although shown in cross-section, the embossed roller 1602 may have a variety of lengths that may correspond to the width of the layer of material fed to the embossed roller 1602, or the length may be longer or shorter than the width of the feed material 1608. When patterned material 1608 disengages from the embossed roller 1602, the surface of the resulting patterned material 1608 includes a pattern of structures 1612 having the predetermined height and predetermined pitch or spacing 1614.

In FIG. 16B, the embossed roller 1602A is positioned opposite a second embossed roller 1602B to provide a pattern on both opposing sides of a porous material 1608. Both embossed rollers 1602A and 1602B are in the form of a wheel. Each of the embossed rollers 1602A, B includes one or more protruded areas 1604A, B and one or more gaps 1606A, B proximate or between the protruded areas 1604A, B. As above, the protruded areas 1604A, B and/or gaps 1606A, B may have uniform dimensions around the circumference of the respective stamps 1602A, B or one or more dimensions may be varied. The protruded areas 1604A, B and gaps 1606A, B form a negative pattern that corresponds to the desired pattern for respective surface of the porous material 1608. The desired pattern involves structures 1612A, B having at least a predetermined height and at least a predetermined pitch or spacing 1614A, B. The respective patterns on embossed rollers 1602A, B may be the same or they may be different.

If the patterns are the same, the embossed rollers 1602A, B may be positioned in an offset manner such that a pattern structure 1612A on one side of the of patterned porous material 1608 is positioned opposite a pattern spacing 1614B on the other side of the porous material 1608. The porous material 1608 is also fed to the embossed rollers 1602A, B substantially continuously, for example, in a roll-to-roll process. However, the speed at which the porous material is fed to the embossed rollers 1602A, B may vary. Once the porous material has a patterned surface (either directly or coupled with a patterned material layer) with the predetermined height and spacing, the material may be ready for use. However, in certain embodiments, a coating is applied to the material prior to use.

Alternatively, materials with patterned surfaces on two major sides may be produced by laminating two patterned layers together. The resulting laminated patterned porous material includes a plurality of raised structures on both major sides of the material. The sides may be the same or similar, or may be different from one another, for example having different chemical composition or patterning.

According to some embodiments, the patterned material (e.g., second layer) may be prepared by phase-inversion micromolding. Phase-inversion micromolding involves forming a membrane by casting a polymer solution onto a patterned substrate and subjecting the cast polymer solution to a phase-inversion process. The formed membrane is then peeled off the patterned substrate. The process may also be performed as a roll-to-roll process with a patterned substrate.

In one embodiment, a polymer solution is cast onto a patterned substrate to prepare a film having a first thickness. A blade at a fixed height may be passed over the film to remove some of the polymer solution and effect a second height. The film may be subjected to (e.g., immersed in) a solvent in which the polymer is not soluble (e.g., water).

A phase-inversion micromolded film may be created or added onto a support layer or substrate. The support layer or substrate may form the first layer or the material, or the phase-inversion micromolded film may be further transferred from the support layer or substrate onto another layer (e.g., the first layer). In some cases, the support layer or substrate is an ePTFE film.

Phase-inversion micromolding may be used to create hierarchical structures where the phase-inversion process creates a microscale structure, while the mold creates a macroscale structure. The microscale structure may include a plurality of nodules and a highly porous structure that extends throughout the layer. The formation of nodules may be further enhanced by increasing the vapor exchange time during phase inversion.

In some embodiments, the polymer solution is cast onto a patterned mold (e.g., a wafer) and the support layer or substrate is laminated onto the polymer solution. In some cases, the patterned mold may be prepared for casting by plasma cleaning. In some cases, the material is subjected to vacuum treatment after casting to remove excess bubbles.

Exemplary polymers for phase-inversion micromolding include polymers that can be dissolved in one solvent and precipitated in another solvent, such as polypropylene, polyethylene, polyester, polysulfone, polyethersulfone, polyvinylpyrrolidone, polyvinylidene fluoride, polyamide (Nylon), polyacrylonitrile, polycarbonate, cellulose acetate, and combinations thereof. Preferred polymers include, for example, polyethersulfone, polysulfone, polyvinylidene fluoride, and cellulose acetate.

According to an embodiment, the material made by phase-inversion micromolding and having both microscale and macroscale structures exhibits a Frazier permeability of 0.1 cfm/ft² (0.051 cm³/s/cm² at 125 Pa) or greater, 0.2 cfm/ft² (0.10 cm³/s/cm² at 125 Pa) or greater, 0.4 cfm/ft² (0.20 cm³/s/cm² at 125 Pa) or greater, 0.5 cfm/ft² (0.25 cm³/s/cm² at 125 Pa) or greater, 0.6 cfm/ft² (0.30 cm³/s/cm² at 125 Pa) or greater, 0.7 cfm/ft² (0.36 cm³/s/cm² at 125 Pa) or greater, 0.8 cfm/ft² (0.41 cm³/s/cm² at 125 Pa) or greater, 0.9 cfm/ft² (0.46 cm³/s/cm² at 125 Pa) or greater, or 1 cfm/ft² (0.51 cm³/s/cm² at 125 Pa) or greater. While there is no desired upper limit on the permeability of the material, in practice, the Frazier permeability of the patterned material may be 3 cfm/ft² (1.52 cm³/s/cm² at 125 Pa) or lower, 2.5 cfm/ft² (1.27 cm³/s/cm² at 125 Pa) or lower, or 2 cfm/ft² (1.02 cm³/s/cm² at 125 Pa) or lower.

The contact angle of a liquid on the material depends on the liquid used for testing, as well as the properties of the material. In some embodiments, the material made from polyethersulfone by phase-inversion micromolding exhibits a contact angle of 75° or greater, 80° or greater, 85° or greater, or 90° or greater, when tested using KAYDOL mineral oil. In some embodiments, the material made from polyethersulfone by phase-inversion micromolding exhibits a roll-off angle of 35° or less, 33° or less, 30° or less, or 25° or less.

One of the advantages of a phase-inversion micromolded material may be a more limited loss of permeability as compared to imprinted patterns. Membranes prepared by phase-inversion micromolding may shrink upon formation (e.g., upon removal of the solvent). This may result in stretching and enlarging of pores between pattern features. This may improve permeability and maintain permeability when the membrane comes into contact with contaminants. Phase-inversion micromolding may also be used to create pattern structures with more defined (e.g., sharper) corners and taller shapes, which may further improve liquid-phobic properties.

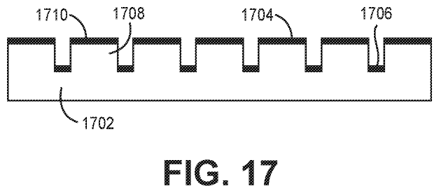

FIG. 17 is a schematic cross-sectional view of a patterned porous material 1702 including a coating 1710. The coating may be applied to the outer surface of the patterned porous material 1702 including one or more of the tops of the plurality of structures 1704, the bottom of the spaces between the plurality of structures 1706, and the sides of the plurality of structures 1708. The coating may be applied before or after the pattern is formed on the porous material. The coating may be applied to improve the oleophobicity of the porous material. Example coatings may include fluoropolymers or a perfluoropolyether (PFPE) bottlebrush polymer, including those described in U.S. Provisional Patent Application Ser. No. 63/067,053 filed on Aug. 18, 2020, and in U.S. Provisional Patent Application Ser. No. 63/185,084 filed on Feb. 3, 2021, both of which are incorporated herein by reference. In certain embodiments, the coating may be or include a fluoropolymer comprising poly(2,2,3,3,4,4,4-heptafluorobutyl methacrylate) or poly(2,2,3,3,4,4,4-heptafluorobutyl acrylate).

As described above, structured patterns can be designed to improve the hydrophobicity and/or oleophobicity of a filter media material or venting media with respect to an expected contaminant by controlling the height and pitch, or spacing, of the structures. Patterned filter media with, or without, a coating may improve performance and longevity in venting applications where filter media is exposed to potential liquid contaminants that are difficult to release from the filter media surface. The increase in release properties can allow for a reduction, or elimination, of environmentally unfriendly bio-persistent chemical coatings.

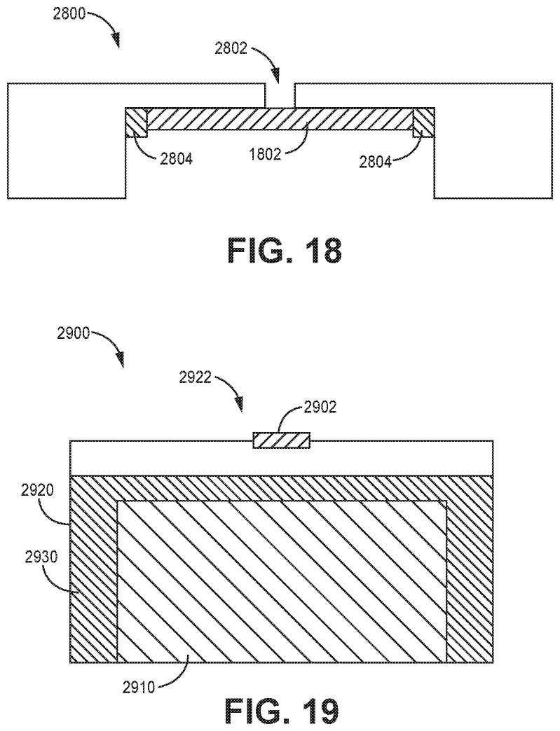

Generally, the venting media of the present disclosure may be used in various venting applications. A schematic diagram of a generic venting apparatus 2800 is shown in FIG. 18. The venting apparatus 2800 includes an opening (vent) 2802 to provide airflow to the environment. The opening 2802 is occluded by patterned porous material 1802. The patterned porous material 1802 includes a layer porous material that includes a plurality of raised structures disposed on the surface of the layer, as described herein. The patterned porous material 1802 may optionally be coated with a coating. The patterned porous material 1802 may be attached to the venting apparatus 2800 by a suitable attachment 2804, such as an adhesive, a heat weld, an ultrasonic weld, overmolding, interference fit, or the like.

According to an embodiment, the venting media of the present disclosure is used in battery pack venting applications, for example in battery packs used in electric vehicles. Battery packs may be surrounded by an enclosure filled with air or an active cooling liquid such as an oil. In particular, lithium ion batteries, which are susceptible to thermal runaway, may be surrounded by a cooling oil to provide cooling to the battery. If the pack is surrounded by oil, the oil may contact the battery pack vent, which may result in filming over and reduced permeability of the vent. According to an embodiment, the battery pack vent includes the venting media of the present disclosure. By using the venting media of the present disclosure, the oil will drain quickly, avoiding filming over, and the vent will recover its permeability. According to an embodiment, shown in FIG. 19, a battery pack 2900 includes one or more batteries 2910 disposed within an enclosure 2920 and a cooling oil 2930 at least partially surrounding the one or more batteries 2910. The batteries 2910 may be lithium ion batteries. The enclosure 2920 includes one or more vents 2922 occluded by the venting media 2902. In some embodiments, the venting media 2902 is or includes patterned cellulose acetate media. In some embodiments, the venting media 2902 is coated.

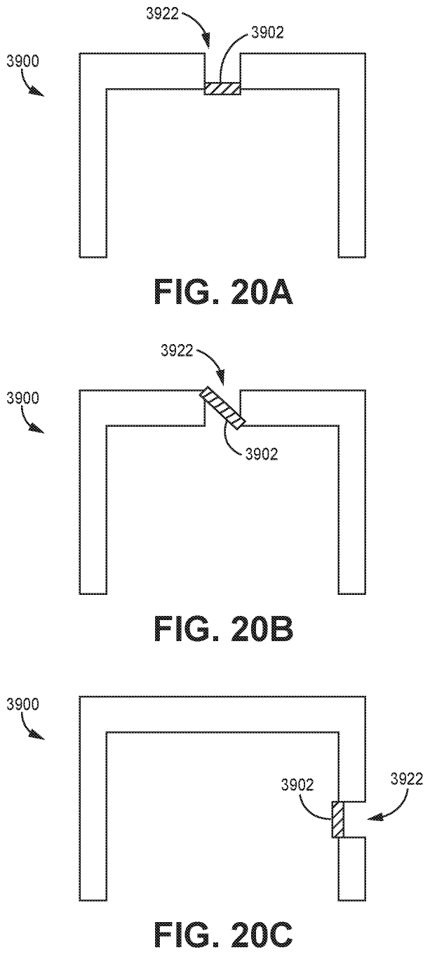

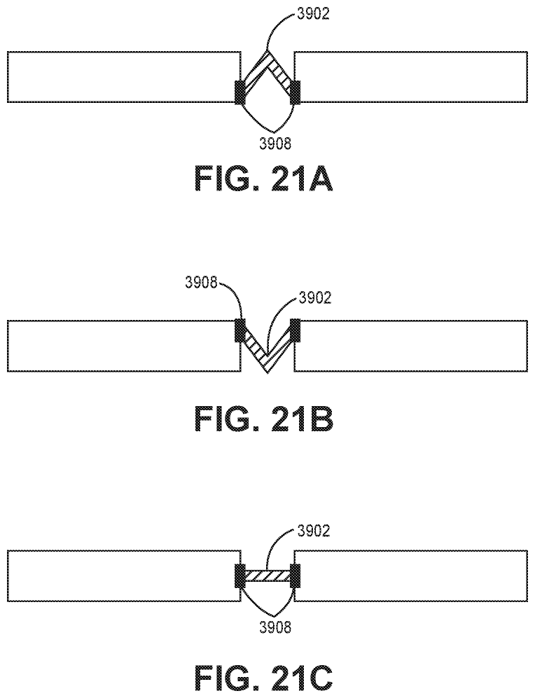

According to an embodiment, the venting media of the present disclosure is used in packing material venting applications. Many packaging vent applications use vents due to pressure and/or temperature changes during shipping or storage. For example, during shipping or handling, liquid products may move within the package or the package may fall on its side, causing contamination of the vent surface by the liquid product inside the package. According to an embodiment, the package vent includes the venting media of the present disclosure. By using the venting media of the present disclosure, the liquid will drain quickly, avoiding filming over, and the vent will recover its permeability, thus allowing air flow to continue when the bottle is upright or after splashing. Additionally, the venting media (particularly coated venting media) may help increase intrusion pressure when the vent is contacted by the liquid (e.g., when the package is laying on its side), preventing liquid from leaking through the vent. The vent may be located on the main part of the packaging or on a lid, cap, or an insert. According to an embodiment, shown in FIGS. 20A-20C, a package 3900 (e.g., a cap or insert) includes one or more vents 3922 occluded by the venting media 3902. The venting media 3902 may be attached on or over the vent 3922 in various ways or at various locations, as exemplified in FIGS. 20A-20C and 21A-21C. The venting media may be attached by any suitable attachment, for example, by an adhesive, a heat weld, an ultrasonic weld, overmolding, interference fit, or the like. In FIGS. 21A-21C, the venting media is attached by a weld 3908. In some embodiments, the venting media 3902 is or includes patterned cellulose acetate media. In some embodiments, the venting media 3902 is coated.

### ILLUSTRATIVE EMBODIMENTS

The technology described herein is defined in the claims. However, below is provided a non-exhaustive listing of non-limiting embodiments. Any one or more of the features of these embodiments may be combined with any one or more features of another example, embodiment, or aspect described herein.

Embodiment 1 is a filter media, comprising: a layer of porous material having a patterned outer surface comprising a plurality of pillars, wherein each pillar in the plurality has at least a predetermined height based on an expected contaminant and spacing between each pillar in a pair of pillars in the plurality is at most a predetermined spacing based on the expected contaminant.

Embodiment 2 is the filter media of any one of embodiments 1 and 3-13, wherein the porous material is a membrane.

Embodiment 3 is the filter media of any one of embodiments 1-2 and 4-13, wherein the membrane comprises one of polypropylene, polyethylene, polyester, polyethersulfone, polysulfone, expanded polytetrafluoroethylene, polyvinylidene fluoride, polyamide, polyacrylonitrile, polycarbonate, and cellulose acetate.

Embodiment 4 is the filter media of any one of embodiments 1-3 and 5-13, wherein the predetermined height is determined based on the relationship

$$h = \frac{{p}^{2}}{AL} ( \frac{1 - ϕ}{cos {θ}_{unpatterned}} - ϕ + 1 ) ,$$

where h is the predetermined height, p is pitch of the pillars, A is number of pillars per unit surface area, ϕ is the pattern solid fraction of the patterned outer surface, and θ_{unpatterned} is contact angle on an unpatterned layer of an otherwise identical porous material.

Embodiment 5 is the filter media of any one of embodiments 1-4 and 6-13, wherein the predetermined spacing is determined based on the relationship

$${P}_{wet} = \frac{{F}_{CL}}{A} ,$$

where P_{wet} is wetting pressure into the plurality of pillars, F_{CL} is contact line force, and A is projected area of a meniscus between a plurality of pillars.

Embodiment 6 is the filter media of any one of embodiments 1-5 and 7-13, wherein the predetermined height and predetermined spacing provide a roll-off angle in a range of 0-20 for a 20 microliter droplet for expected contaminants having a surface tension equal to or less than 72 mN/m.

Embodiment 7 is the filter media of any one of embodiments 1-6 and 8-13, wherein the patterned layer of porous material has a roll-off angle for the expected contaminant that is lower than a roll-off angle for an otherwise identical non-patterned layer.

Embodiment 8 is the filter media of any one of embodiments 1-7 and 9-13, wherein the layer of porous material further comprises a coating that increases oleophobicity of the layer.

Embodiment 9 is the filter media of any one of embodiments 1-8 and 10-13, wherein the coating is a fluoropolymer comprising poly(2,2-3,3-4,4,4-heptafluorobutyl methacrylate) or poly(2,2-3,3-4-4-4-heptafluorobutyl acrylate).

Embodiment 10 is the filter media of any one of embodiments 1-9 and 11-13, wherein the coating comprises a perfluoropolyether (PFPE) bottlebrush polymer.

Embodiment 11 is the filter media of any one of embodiments 1-10 and 12-13, wherein the plurality of pillars comprises a pattern solid fraction of the outer surface of 0.75 or less.

Embodiment 12 is the filter media of any one of embodiments 1-11 and 13, wherein the porous material has a pore size of at least 0.05 μm and a permeability of at least 0.05 cfm/ft² (0.025 cm³/s/cm² at 125 Pa) before the outer surface is patterned.

Embodiment 13 is the filter media of any one of embodiments 1-12, wherein the patterned layer of porous material has a permeability of at least 10% of a permeability of an otherwise identical non-patterned layer.

Embodiment 14 is a filter media, comprising: a layer of porous material having a patterned outer surface comprising a plurality of structures, wherein each structure in the plurality has at least a predetermined height based on an expected contaminant and spacing between each structure in a pair of structures in the plurality is at most a predetermined spacing based on the expected contaminant.

Embodiment 15 is the filter media of any one of embodiments 14 and 16-21, wherein the predetermined height is determined based on the relationship

$$h = \frac{{p}^{2}}{AL} ( \frac{1 - ϕ}{cos {θ}_{unpatterned}} - ϕ + 1 ) ,$$

where h is the predetermined height, p is pitch of the structures, A is number of structures per unit surface area, ϕ is pattern solid fraction of the patterned outer surface, and θ_{unpatterned} is contact angle on an unpatterned layer of an otherwise identical porous material.

Embodiment 16 is the filter media of any one of embodiments 14-15 and 17-21, wherein the predetermined spacing is determined based on the relationship

$${P}_{wet} = \frac{{F}_{CL}}{A} ,$$

where P_{wet} is wetting pressure into the plurality of structures, F_{CL} is contact line force, and A is area of a meniscus between a plurality of structures.

Embodiment 17 is the filter media of any one of embodiments 14-16 and 18-21, wherein the predetermined height and predetermined spacing provide a roll-off angle in a range of 0-20 for a 20 microliter droplet for expected contaminants having a surface tension equal to or less than 72 mN/m.

Embodiment 18 is the filter media of any one of embodiments 14-17 and 19-21, wherein the patterned layer of porous material has a roll-off angle for the expected contaminant that is lower than a roll-off angle for a non-patterned layer of an otherwise identical porous material and expected contaminant.

Embodiment 19 is the filter media of any one of embodiments 14-18 and 20-21, wherein the plurality of structures comprises a pattern solid fraction of the outer surface of 0.75 or less.

Embodiment 20 is the filter media of any one of embodiments 14-19 and 21, wherein the patterned layer of porous material has a permeability of at least 10% of a permeability of an otherwise identical non-patterned layer.

Embodiment 21 is the filter media of any one of embodiments 14-20, wherein the predetermined height is less than 12 microns.

Embodiment 22 is a filter media, comprising: a first layer of porous material; and a second layer of material disposed on the first layer, the second layer having a patterned outer surface comprising a plurality of structures, wherein each structure in the plurality has at least a predetermined height based on an expected contaminant and spacing between each structure in a pair of structures in the plurality is at most a predetermined spacing based on the expected contaminant.

Embodiment 23 is the filter media of any one of embodiments 22 and 24-32, wherein the first layer and the second layer comprise the same material.

Embodiment 24 is the filter media of any one of embodiments 22-23 and 25-32, wherein the second layer comprises at least one of polymeric fibers, metal meshes, expanded polytetrafluoroethylene, phase inverted membrane, particle-laden coating, and laser etched material.

Embodiment 25 is the filter media of any one of embodiments 22-24 and 26-32, wherein the second layer is laminated on the first layer.

Embodiment 26 is the filter media of any one of embodiments 22-25 and 27-32, wherein the first layer comprises expanded polytetrafluoroethylene having pores of a first size and the second layer comprises expanded polytetrafluoroethylene having pores of a second, larger size.

Embodiment 27 is the filter media of any one of embodiments 22-26 and 28-32, wherein the plurality of structures have a re-entrant geometry.

Embodiment 28 is the filter media of any one of embodiments 22-27 and 29-32, wherein the predetermined height is determined based on the relationship

$$h = \frac{{p}^{2}}{AL} ( \frac{1 - ϕ}{cos {θ}_{unpatterned}} - ϕ + 1 ) ,$$

where h is the predetermined height, p is pitch of structures, A is number of structures per unit surface area, ϕ is pattern solid fraction of the patterned outer surface, and θ_{unpatterned} is contact angle on an unpatterned layer of an otherwise identical porous material.

Embodiment 29 is the filter media of any one of embodiments 22-28 and 30-32, wherein the predetermined spacing is determined based on the relationship

$${P}_{wet} = \frac{{F}_{CL}}{A} ,$$

where P_{wet} is wetting pressure into the plurality of structures, F_{CL} is contact line force, and A is area of a meniscus between a plurality of structures.

Embodiment 30 is the filter media of any one of embodiments 22-29 and 31-32, wherein the second layer further comprises a coating that increases oleophobicity of the second layer.

Embodiment 31 is the filter media of any one of embodiments 22-30 and 32, wherein the coating is a fluoropolymer comprising poly(2,2,3,3,4,4,4-heptafluorobutyl methacrylate) or poly(2,2,3,3,4,4,4-heptafluorobutyl acrylate).

Embodiment 32 is the filter media of any one of embodiments 22-31, wherein the coating comprises a perfluoropolyether (PFPE) bottlebrush polymer.

Embodiment 33 is a filter media comprising: a layer of porous material having a hierarchical structure and a patterned outer surface comprising a plurality of structures, wherein each structure in the plurality has at least a predetermined height based on an expected contaminant and spacing between each structure in a pair of structures in the plurality is at most a predetermined spacing based on the expected contaminant.

Embodiment 34 is the filter media of any one of embodiments 33 and 35-39, wherein the predetermined height is determined based on the relationship

$$h = \frac{{p}^{2}}{AL} ( \frac{1 - ϕ}{cos {θ}_{unpatterned}} - ϕ + 1 ) ,$$

where h is the predetermined height, p is pitch of structures, A is number of structures per unit surface area, ϕ is pattern solid fraction of the patterned outer surface, and θ_{unpatterned} is contact angle on an unpatterned layer of an otherwise identical porous material.

Embodiment 35 is the filter media of any one of embodiments 33-34 and 36-39, wherein the predetermined spacing is determined based on the relationship

$${P}_{wet} = \frac{{F}_{CL}}{A} ,$$

where P_{wet} is wetting pressure into the plurality of structures, F_{CL} is contact line force, and A is area of a meniscus between a plurality of structures.

Embodiment 36 is the filter media of any one of embodiments 33-35 and 37-39, wherein the layer of porous material further comprises a coating that increases oleophobicity of the second layer.

Embodiment 37 is the filter media of any one of embodiments 33-36 and 38-39, wherein the porous material is a phase-inverted material.

Embodiment 38 is the filter media of any one of embodiments 33-37 and 39, wherein the porous material comprises a particle coating on a membrane comprising one of polypropylene, polyethylene, polyester, polyethersulfone, polysulfone, expanded polytetrafluoroethylene, polyvinylidene fluoride, polyamide, polyacrylonitrile, polycarbonate, and cellulose acetate.

Embodiment 39 is the filter media of any one of embodiments 33-38, wherein the hierarchical structure of the porous material comprises microscale features and macroscale features. The microscale features may comprise nodules.

Embodiment 40 is a venting apparatus comprising: an opening configured to vent an enclosure; and a venting element affixed within the venting apparatus and forming a liquid-tight, gas-permeable seal of the opening, wherein the venting element comprises porous material having a patterned surface comprising a plurality of structures, wherein each structure in the plurality has at least a predetermined height based on an expected contaminant and spacing between each structure in a pair of structures in the plurality is at most a predetermined spacing based on the expected contaminant.

Embodiment 41 is a method comprising: providing a layer of porous material; providing a stamp having a patterned outer surface that corresponds to a negative of a pattern comprising a plurality of structures, wherein each structure in the plurality has at least a predetermined height based on an expected contaminant and spacing between each structure in a pair of structures in the plurality is at most a predetermined spacing based on the expected contaminant; and applying the stamp to a first surface of the layer of porous material at a predetermined temperature and pressure to form the pattern of the plurality of structures having the predetermined height and spacing on the first surface of the layer of porous material.

Embodiment 42 is the method of any one of embodiments 41 and 43-46, wherein the stamp is a circular stamp and providing the layer of porous material comprises providing a roll of porous material to form the pattern of the plurality of structures in a roll-to-roll process or a roll-to-plate process.

Embodiment 43 is the method of any one of embodiments 41-42 and 44-46, further comprising: providing a second stamp having a second patterned outer surface that corresponds to a negative of a second pattern comprising a plurality of structures, wherein each structure in the plurality has at least a predetermined height based on an expected contaminant and spacing between each structure in a pair of structures in the plurality is at most a predetermined spacing based on the expected contaminant; and applying the second stamp to a second, opposing surface of the layer of porous material at a predetermined temperature and pressure to form the pattern of the plurality of structures having the predetermined height and spacing on the second surface of the layer of porous material.

Embodiment 44 is the method of any one of embodiments 43 and 45-46, wherein the first pattern and the second pattern have the same predetermined height and predetermined spacing.

Embodiment 45 is the method of any one of embodiments 43-44 and 46, wherein the first pattern has at least one of a different predetermined height and a different predetermined spacing as compared with the second pattern.

Embodiment 46 is the method of any one of embodiments 43-45, wherein providing the layer of porous material comprises providing a roll of porous material and the stamp and the second stamp are circular stamps configured to form the pattern of the plurality of structures in a roll-to-roll process or a roll-to-plate process.

Embodiment 47 is a filter media, comprising: a layer of porous material having a patterned outer surface comprising a plurality of raised structures, wherein each raised structure in the plurality has a height in a range of 1 μm to 40 μm and center-to-center spacing between pairs of raised structures in the plurality is in a range of 1 μm to 100 μm.

Embodiment 48 is the filter media of embodiment 47, wherein the patterned outer surface exhibits a roll-off angle of 35° or less, 30° or less, 25° or less, or 20° or less when exposed to a liquid having a surface tension of 20 mN/m or greater, measured using a droplet size of 20 μm.

Embodiment 49 is the filter media of embodiment 47 or 48, wherein the patterned surface in contact with a contaminant exhibits a contact angle that is at least 5° higher, at least 15° higher, at least 20° higher, or at least 25° higher than the porous material without a patterned surface.

Embodiment 50 is the filter media of any one of embodiments 47 to 49, wherein the patterned surface in contact with a contaminant exhibits a receding contact angle that is 50° or greater, 60° or greater, 70° or greater, 80° or greater, or 90° or greater.

Embodiment 51 is the filter media of any one of embodiments 47 to 50, wherein the plurality of raised structures have a pattern solid fraction in a range of 0.1 to 0.8, 0.2 to 0.75, or 0.25 to 0.75.

Embodiment 52 is the filter media of any one of embodiments 47 to 51, wherein the porous material is a membrane.

Embodiment 53 is the filter media of embodiment 52, wherein the membrane comprises one of polypropylene, polyethylene, polyester, polyethersulfone, polysulfone, expanded polytetrafluoroethylene, polyvinylidene fluoride, polyamide, polyacrylonitrile, polycarbonate, and cellulose acetate.

Embodiment 54 is the filter media of any one of embodiments 47 to 53, wherein the layer of porous material further comprises a coating that increases oleophobicity of the layer.

Embodiment 55 is the filter media of embodiment 54, wherein the coating is a fluoropolymer, optionally wherein the coating comprises a perfluoropolyether (PFPE) bottlebrush polymer.

Embodiment 56 is the filter media of any one of embodiments 47 to 55, wherein the porous material has a pore size of at least 0.05 μm and a Frazier permeability of at least 0.05 cfm/ft² at 0.5″ water pressure drop (0.025 cm³/s/cm² at 125 Pa) before the porous material is patterned.

Embodiment 57 is the filter media of any one of embodiments 47 to 56, wherein the patterned layer of porous material has a Frazier permeability of 0.1 cfm/ft² at 0.5″ water pressure drop (0.051 cm³/s/cm² at 125 Pa) to 3 cfm/ft² at 0.5″ water (1.52 cm³/s/cm² at 125 Pa), 0.3 cfm/ft² at 0.5″ water (0.15 cm^{3 /}s/cm² at 125 Pa) to 3 cfm/ft² at 0.5″ water (1.52 cm³/s/cm² at 125 Pa), or 0.5 cfm/ft² at 0.5″ water (0.25 cm³/s/cm² at 125 Pa) to 3 cfm/ft² at 0.5″ water (1.52 cm³/s/cm² at 125 Pa).

Embodiment 58 is the filter media of any one of embodiments 47 to 57, wherein the layer of porous material comprises a hierarchical structure comprising at least microscale features and macroscale features, wherein the macroscale features are formed by pores of the porous material or the plurality of raised structures or both.

Embodiment 59 is the filter media of embodiment 58, wherein the porous material comprises a phase-inverted material.

Embodiment 60 is the filter media of embodiment 58 or 59, wherein the porous material comprises polypropylene, polyethylene, polyester, polysulfone, polyethersulfone, polyvinylpyrrolidone, polyvinylidene fluoride, polyamide (Nylon), polyacrylonitrile, polycarbonate, cellulose acetate, or a combination thereof, preferably wherein the porous material comprises polyethersulfone, polysulfone, polyvinylidene fluoride, or cellulose acetate.

Embodiment 61 is the filter media of any one of embodiments 47 to 60, wherein all of the pairs of raised structures have equal spacing.

Embodiment 62 is the filter media of any one of embodiments 47 to 61, wherein the raised structures comprise pillars, ribs, or splines.

Embodiment 63 is a vented battery pack comprising one or more batteries disposed within an enclosure and cooling oil at least partially surrounding the one or more batteries, the enclosure comprising one or more vents and venting media occluding the one or more vents, the venting media comprising the filter media of any one of embodiments 1 to 62.

Embodiment 64 is the vented battery pack of embodiment 63, wherein the one or more batteries are lithium ion batteries.

Embodiment 65 is the vented battery pack of embodiment 63 or 64, wherein the venting media comprises patterned cellulose acetate media. The venting media may be coated.

Embodiment 66 is a vented packaging comprising one or more vents occluded by venting media, the venting media comprising the filter media of any one of embodiments 1 to 62.

Embodiment 67 is the vented packaging of embodiment 66, wherein the one or more vents are located on a cap or insert.

Embodiment 68 is the vented packaging of embodiment 66 or 67, wherein the venting media comprises patterned cellulose acetate media. The venting media may be coated.

### EXAMPLES

Pattern dimensions were measured using a 3D Laser Scanning Confocal Microscope (VK-X, Keyence, Osaka, Osaka, Japan). Dimensions can be discerned from a 3D image by taking a line profile and making measurements. Pattern height can also be determined by plotting a histogram of the height data in the entire 3D image.

Samples were imprinted using a Nanoimprint Lithography station (CNI v2.1, NIL Technology, Kongens Lyngby, Denmark). Imprinting pressures ranged from 0.3 to 11 bar and imprinting temperatures ranged from 0° C. to 200° C.

The media used in the following examples, as described by Media 1, is an expanded PTFE membrane with a mean pore size of about 0.2 μm, thickness of about 9 mil, and Frazier air permeability of about 0.15 cfm/ft² (0.076 cm³/s/cm² at 125 Pa).

### Example 1

One side of Media 1 was patterned via nanoimprint lithography. A patterned stamp was used for imprinting, fabricated via photolithography using SU-8 photoresist (Kayaku Advanced Materials, Massachusetts, USA) on a silicon wafer. The imprinted pattern on ePTFE was an array of lines with s=10 μm, h=4.2 μm, and φ=0.5. Droplets (20 μL) were pipetted onto the patterned ePTFE surface for contact angle and roll-off angle measurements.

The contact angle and the roll-off angle of a substrate were measured using a DropMaster DM-701 contact angle meter equipped with a tilt stage (Kyowa Interface Science Co., Ltd.; Niiza-City, Japan). Measurements were performed using the standard camera lens setting and calibrated using a 6 millimeter (mm) calibration standard with the FAMAS software package (Kyowa Interface Science Co., Ltd.; Niiza-City, Japan). Measurements were taken only after the droplet had reached equilibrium on the surface (that is, the contact angle and exposed droplet volume was constant for one minute). Measurements were taken of droplets that were in contact with only the substrate, that is, the droplet was not in contact with any surface supporting the substrate.

Contact angles for a first liquid and a second liquid were measured using 20 μL drops of each liquid deposited on a substrate sample. Contact angles were measured using a tangent fit and were calculated from an average of three to five independent measurements taken on different areas of the substrate.

Roll-off angles for a first liquid and a second liquid were measured using 20 μL drops of each liquid deposited on a substrate sample, here a patterned or unpatterned membrane. The stage was set to rotate to 90° at a rotation speed of 2 degrees per second (°/sec). At the point when the droplet freely rolled away, or the rear contact line moved at least 0.4 millimeters (mm) relative to the media surface, the rotation was stopped. The angle at the time the rotation was stopped was measured; this angle is defined as the roll-off angle. If the droplet did not roll-off before 90 degrees (°), the value is reported as 90°. If the droplet rolled away during the deposition process, the value is reported at 1°. Reported values were calculated from an average of five independent measurements taken on different areas of media. When data was measured for line structures, they were measured parallel to the tilting plane.

Contact and roll-off angles were also measured on an otherwise identical, unpatterned ePTFE surface. The first liquid, Liquid 1, was water (72 mN/m), and the second liquid, Liquid 2, was a homogenous mixture of 80:20 water:IPA (33 mN/m).

Table 2 shows that the patterned membrane shows superhydrophobic performance (θ>150° and roll-off angle<10°). In general, the patterned membrane increases the contact angle and reduces roll-off angles.

TABLE 2

| | Contact Angle (°) | | Roll-off Angle (°) | |
|---|---|---|---|---|
| | Unpatterned | Patterned | Unpatterned | Patterned |
| Liquid 1 | 144.8 | 155.4 | 24.6 | 9.1 |
| Liquid 2 | 118.4 | 127.4 | 83.6 | 25.3 |

### Example 2

One side of Media 1 was patterned via nanoimprint lithography. A patterned stamp was used for imprinting, fabricated via photolithography using SU-8 on a silicon wafer. The imprinted pattern on ePTFE was an array of lines with s=25 μm, h=10 μm, and φ=0.5. The ePTFE membrane (patterned and unpatterned) was dip coated in a 3% w/v fluoroacrylate polymer in Novec 7200 (3M, Saint Paul, MN, USA) to render it oleophobic. Contact and roll-off angles were taken as in Example 1 with 20 μL droplets. Liquid 1 was water (72 mN/m) and Liquid 2 was a homogenous mixture of 80:20 water:IPA (33 mN/m).

Table 3 shows for both liquids that patterning the membrane leads to an observed decrease in roll-off angle and increase in contact angle. Solely coating the membrane with an oleophobic coating does not improve drainage of liquids, instead, in this case both coating and patterning does.

TABLE 3

| | Contact Angle (°) | | | Roll-off Angle (°) | | |
|---|---|---|---|---|---|---|
| | | | Patterned | | | Patterned |
| | Uncoated | Coated | & Coated | Uncoated | Coated | & Coated |
| Liquid 1 | 144.8 | 146.2 | 161.1 | 24.6 | 49.9 | 8.7 |
| Liquid 2 | 118.4 | 125.8 | 137.7 | 83.6 | 68.6 | 21.7 |

### Example 3

One side of cellulose acetate (CA0459025, Sterlitech, Kent, WA, USA) was patterned via nanoimprint lithography (FIG. 8C). A patterned stamp was used for imprinting, fabricated via photolithography using SU-8 on a silicon wafer. The imprinted pattern on cellulose acetate was an array of lines with s=10 μm and φ=0.5. The pattern height was varied, as seen in Table 4. The cellulose acetate membrane (patterned and unpatterned) was dip coated in a 3% w/v fluoroacrylate polymer in Novec 7200 (3M, Saint Paul, MN, USA) to render it oleophobic.

Contact and roll-off angles were taken as in Example 1 with 20 μL droplets. The liquid tested was gear oil (Hypoid Gear Oil HGO-1 GL-5 75W-85, Honda, Minato City, Tokyo, Japan).

Frazier permeabilities were measured of each sample before and after contamination with gear oil. For contamination, gear oil was pipetted onto each sample and the sample was held vertically for 30 minutes to allow for drainage prior to measuring permeability.

Table 4 indicates that patterning the cellulose acetate reduces the roll-off angle and increases retained permeability, however, the pattern fails if its height is too low. The pattern with a height of only 2.6 μm does not perform markedly better than the unpatterned cellulose acetate. Only the pattern with a height of 4.0 μm retains significantly more permeability than the unpatterned membrane. Further, the image in FIG. 8C supports the gear oil being in a Cassie state on the patterned cellulose acetate as the liquid resides on the tops of the pattern and no liquid is found in the valleys of the pattern.

TABLE 4

| | | | Roll- | Permeability | Permeability | |
|---|---|---|---|---|---|---|
| | Pattern | Contact | off | Before | After | |
| | Height | Angle | Angle | Contamination | Contamination | % Original |
| | (μm) | (°) | (°) | (cfm/ft²) | (cfm/ft²) | Permeability |
| Unpatterned | N/A | 147.5 | 54 | 0.441 | 0.012 | 3 |
| Patterned | 4.0 | 159.1 | 18 | 0.194 | 0.142 | 73 |
| Patterned | 2.6 | 157 | 48 | 0.239 | 0.013 | 9 |

### Example 4

One side of Media 1 was patterned via nanoimprint lithography. A patterned stamp was used for imprinting, fabricated via photolithography using SU-8 on a silicon wafer. The imprinted pattern on ePTFE was an array of lines with s=10 μm, h=3.6 μm, and φ=0.5. The ePTFE membrane (patterned and unpatterned) was dip coated in a 3% w/v fluoroacrylate polymer in Novec 7200 (3M, Saint Paul, MN, USA) to render it oleophobic. Contact and roll-off angles were taken as in Example 1 with 20 μL droplets. Diesel exhaust fluid (DEF, BlueDEF, Old World Industries, Northbrook, IL, USA) and engine oil (Mobil 1 Advanced Fuel Economy 0W-20, Mobil 1, Irving, TX, USA) were used. DEF has a surface tension of 73 mN/m and engine oil has a surface tension of 29 mN/m.

Table 5 shows permeability before and after contamination with each fluid. The permeability is not affected after contamination with DEF as ePTFE repels water-based contaminates easily. Permeability is not recovered, however, after contamination with engine oil on the unpatterned ePTFE membrane. The patterned ePTFE recovers more permeability than the unpatterned ePTFE after contamination with engine oil. This is due to the increased ability of the patterned ePTFE membrane to drain off liquids. For liquids with surface tensions lower than 29 mN/m, Pwet may need to be increased as calculated through Equation 3. For example, a surface tension of 24 mN/m would require a maximum spacing between features of 1 μm.

TABLE 5

| | | | Roll- | Permeability | Permeability | |
|---|---|---|---|---|---|---|
| | Surface | Contact | off | Before | After | |
| | Tension | Angle | Angle | Contamination | Contamination | % Original |
| | (mN/m) | (°) | (°) | (cfm/ft²) | (cfm/ft²) | Permeability |
| Unpatterned | 73 | 145.4 | 43.4 | 0.164 | 0.179 | 109 |
| | 29 | 120.5 | 69.0 | | 0.002 | 1 |
| Patterned | 73 | 152.7 | 11.9 | 0.051 | 0.060 | 118 |
| | 29 | 128.6 | 60.7 | | 0.013 | 26 |

### Example 5

Polymer dope solutions were prepared with polyethersulfone (PES; M_{w} 72,000 and dispersity index 3.4), polyvinylpyrrolidone (PVP; M_{w} 360,000; Sigma Aldrich), and N-methyl-2-pyrrolidinone (NMP; Sigma Aldrich). The composition for all dope solutions used in Examples 5-7 was 20 wt. % PES, 10 wt. % PVP, and 70 wt. % NMP. Dope solutions were cast onto a silicon wafer patterned via photolithography using SU-8 photoresist.

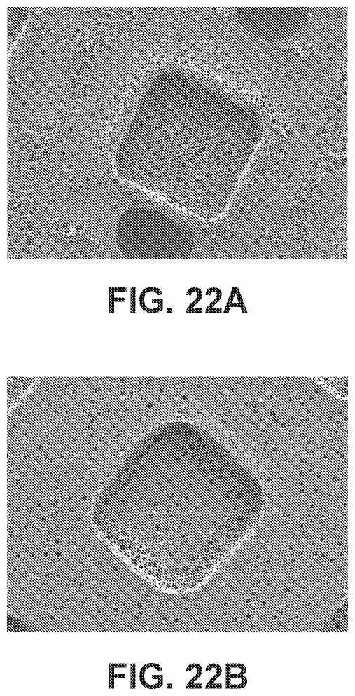

The patterned silicon wafer used in this Example included an array of squares with s=100 μm and pattern solid fraction (φ) of 0.25. The dope solution was cast onto the patterned silicon wafer with a casting thickness of 100 μm using a casting knife. The casted polymer film first underwent vapor induced phase separation (VIPS) for 30 seconds with a fan circulating humid air (RH 99%) and then underwent non-solvent induced phase separation (NIPS) by submerging the casted film on the wafer into a heated water bath at 60° C. for one minute. The film was then rinsed in a deionized water bath at room temperature for at least 5 minutes. FIG. 22A shows a membrane cast using this process. An air bubble is evident adjacent each structure.

Another membrane was cast and then placed in a vacuum chamber prior to the VIPS process. This eliminated the bubble defects as shown in FIG. 22B.

### Example 6

The same dope solution used in Example 5 was used in Example 6. The dope solution was cast onto a patterned silicon wafer including 10 μm lines with a pattern solid fraction (φ) of 0.75. The cast film was placed in a vacuum chamber to eliminate bubble defects. Then, the film underwent VIPS at 99% RH for 45 seconds with a fan circulating the humid air. The film was then submerged in a 60° C. water bath for one minute (NIPS). The film was then rinsed in a deionized water bath prior to being peeled off of the silicon wafer.

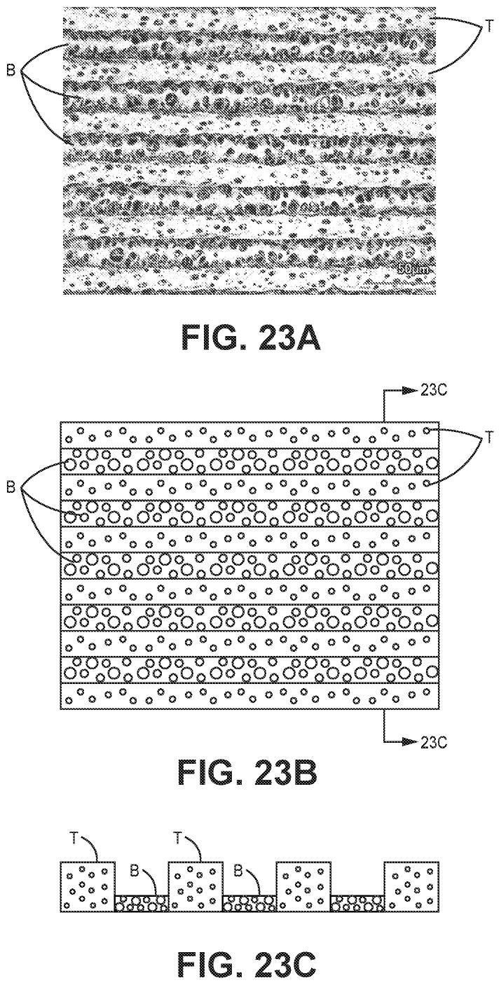

FIG. 23A shows a laser confocal image of the resulting PES membrane. The membrane is schematically shown in FIGS. 23B and 23C. The horizontal stripes T exhibiting smaller pores are the tops of the pattern. The alternating stripes B exhibiting larger pores are the bottoms of the pattern. The differentiated pore size between the top and bottom of the pattern is evident, due to the membrane shrinking from the casting process.

It is hypothesized that liquids in a Cassie state on this pattern would solely be in contact with the tops of the pattern, leaving the bottoms of the pattern open for air flow.

### Example 7

The same dope solution used in Example 5 was used in Example 7. The dope solution was cast onto a patterned silicon wafer consisting of 50 μm lines with a pattern solid fraction (φ) of 0.5. The cast film was placed in a vacuum chamber to eliminate bubble defects. Then, the film underwent VIPS at 99% RH for 5 minutes with a fan circulating the humid air. The film was then submerged in a 55° C. water bath for one minute (NIPS). The film was then rinsed in a deionized water bath prior to being peeled off of the silicon wafer.

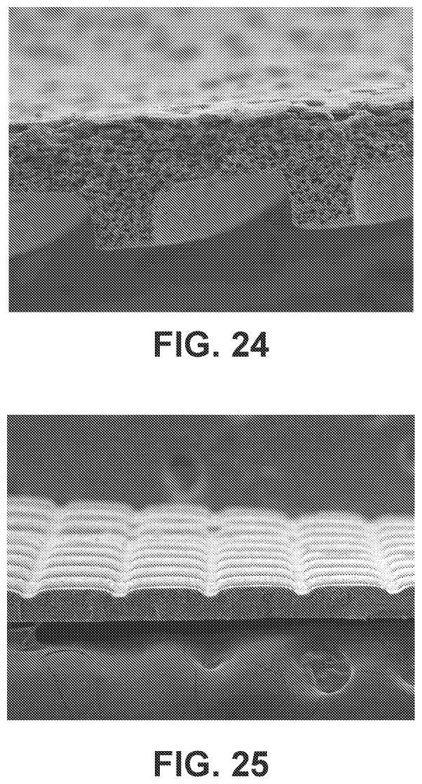

FIG. 24 shows SEM images of the resulting PES membrane. The square cross-section of the pattern is evident, with sharp corners at the tops of the pattern. It was observed that, as compared with other methods (e.g., imprinting), phase inversion micromolding can result in more well-defined features as seen in FIG. 24. It was hypothesized that this is because phase inversion micromolding relies on a liquid polymer solution to penetrate the patterned substrate. Imprinting, for example, relies on a solid polymer to become soft at elevated temperatures and deform and therefore does not typically produce as well-defined features (especially when attempting to retain permeability). An image of an imprinted structure is shown for comparison in FIG. 25.

### Example 8

A polymer dope solution was prepared with cellulose acetate (CA; Mₙ 30,000, Sigma Aldrich) and N-methyl-2-pyrrolidinone (NMP; Sigma Aldrich). The composition of the dope solution was 8 wt. % CA, 19 wt. % DI H₂O, and 73 wt. % NMP. The dope solution was cast onto Media 1 with a casting knife at a thickness of 100 μm. The cast film underwent VIPS at 99% RH for 4 minutes with a fan circulating the humid air. The film was then submerged in a 53° C. water bath for one minute (NIPS) and then rinsed in a deionized water bath for at least 5 minutes.

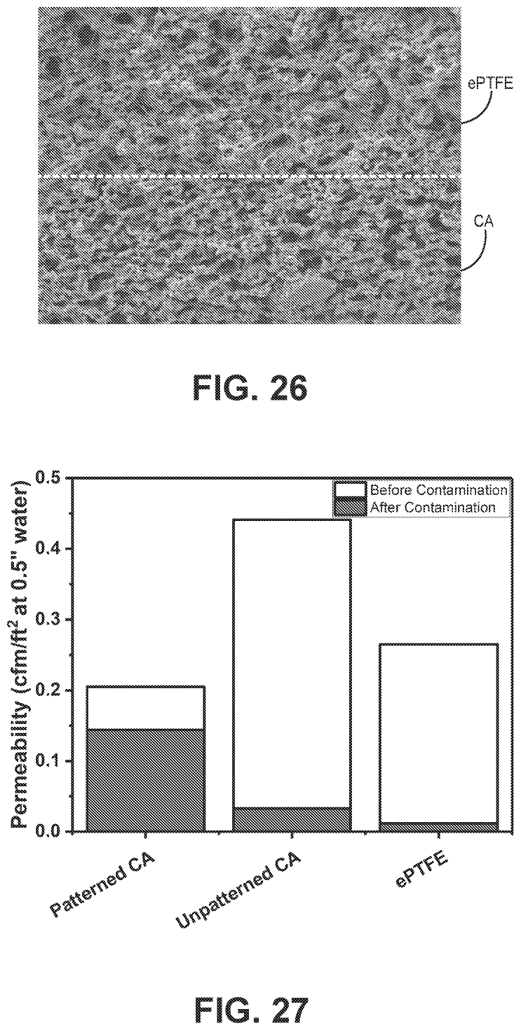

FIG. 26 shows a cross-section of the composite membrane formed. Cellulose acetate (CA) produced a fragile membrane that may be supported by a support structure. The ePTFE membrane provides this function as well as functioning as an efficiency layer. For example, ePTFE membranes that have high water entry pressures may be used. This composite membrane provides dual functionality through the efficient ePTFE layer and the repellent cellulose acetate layer. The cellulose acetate layer is hierarchical and, when patterned, would provide the same benefits to release of liquid contaminants and permeability recovery as described above.

### Example 9

Patterned and unpatterned cellulose acetate (“CA”) membranes were exposed to an E-Fluids oil from Shell used in electric vehicles (SL 2808 Shell E-Fluids E6 iX, Shell, Beijing, China). The permeability of the membranes was measured before and after exposure to the oil using the same test method described in Example 3. The membranes were compared to a commercially available ePTFE membrane [thickness of about 1.9 mils and a Frazier permeability of about 0.23 cfm/ft² at 0.5″ water (0.12 cm³/s/cm² at 125 Pa)]. The results are shown in FIG. 27. Increased permeability recovery was observed for the patterned cellulose acetate membrane.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g., 1 to 5 includes 1, 1.5, 2, 2.75, 3, 3.80, 4, and 5) and any range within that range.

The foregoing description has been presented for the purposes of illustration and description. It is not intended to be exhaustive or to limit the embodiments to the precise form disclosed. It is also not intended to limit the embodiments to aqueous inks or inks that contain water. Many modifications and variations are possible in light of the above teachings. Any or all features of the disclosed embodiments can be applied individually or in any combination and are not meant to be limiting, but purely illustrative. It is intended that the scope of the invention be limited not with this detailed description, but rather, determined by the claims appended hereto.

1. A filter media, comprising:
a layer of porous material having a patterned outer surface comprising a plurality of raised structures, wherein each raised structure in the plurality has a height in a range of 1 μm to 40 μm and center-to-center spacing between pairs of raised structures in the plurality is in a range of 1 μm to 100 μm.

2. The filter media of claim 1, wherein the patterned outer surface exhibits a roll-off angle of 35° or less when exposed to a liquid having a surface tension of 20 mN/m or greater, measured using a droplet size of 20 μm.

3. The filter media of claim 1, wherein the patterned surface in contact with a contaminant exhibits a contact angle that is at least 5° higher than the porous material without a patterned surface.

4. The filter media of claim 1, wherein the patterned surface in contact with a contaminant exhibits a receding contact angle that is 50° or greater.

5. The filter media of claim 1, wherein the plurality of raised structures have a pattern solid fraction in a range of 0.1 to 0.8.

6. The filter media of claim 1, wherein the porous material is a membrane.

7. (canceled)

8. The filter media of claim 1, wherein the layer of porous material further comprises a coating that increases oleophobicity of the layer.

9-11. (canceled)

12. The filter media of claim 1, wherein the porous material has a pore size of at least 0.05 μm and a Frazier permeability of at least 0.05 cfm/ft² at 0.5″ water pressure drop (0.025 cm³/s/cm² at 125 Pa) before the porous material is patterned and wherein the patterned layer of porous material has a Frazier permeability of 0.1 cfm/ft² at 0.5″ water pressure drop (0.051 cm³/s/cm² at 125 Pa) to 3 cfm/ft² at 0.5″ water (1.52 cm³/s/cm² at 125 Pa).

13. (canceled)

14. The filter media of claim 1, wherein the layer of porous material comprises a hierarchical structure comprising at least microscale features and macroscale features, wherein the macroscale features are formed by pores of the porous material or the plurality of raised structures or both.

15. The filter media of claim 14, wherein the porous material comprises a phase-inverted material.

16-17. (canceled)

18. The filter media of claim 1, wherein the layer of porous material is a first layer and wherein the filter media comprises a second layer of porous material disposed on the first layer.

19. (canceled)

20. The filter media of claim 18, wherein the first layer, the second layer, or both the first layer and the second layer comprises at least one of polymeric fibers, metal meshes, expanded polytetrafluoroethylene, phase inverted membrane, particle-laden coating, and laser etched material.

21. (canceled)

22. The filter media of claim 18, wherein the first layer comprises expanded polytetrafluoroethylene having pores of a first size and the second layer comprises expanded polytetrafluoroethylene having pores of a second, larger size.

23. The filter media of claim 18, wherein first layer, the second layer, or both the first layer and the second layer further comprises a coating that increases oleophobicity of the layer.

24-25. (canceled)

26. A venting apparatus comprising:
an opening configured to vent an enclosure; and
a venting element affixed within the venting apparatus and forming a liquid-tight, gas-permeable seal of the opening, wherein the venting element comprises porous material having a patterned outer surface comprising a plurality of raised structures, wherein each raised structure in the plurality has a height in a range of 1 μm to 40 μm and center-to-center spacing between pairs of raised structures in the plurality is in a range of 1 μm to 100 μm.

27. A method comprising:
applying a stamp to a first side of a layer of porous material at a predetermined temperature and pressure to form a pattern of raised structures on a surface of the layer, the stamp comprising a patterned surface that corresponds to a negative of the pattern of raised structures, wherein each raised structure has a height in a range of 1 μm to 40 μm and center-to-center spacing between pairs of raised structures in the plurality is in a range of 1μm to 100 μm.

28. The method of claim 27, wherein the raised structures have a pattern solid fraction in a range of 0.1 to 0.8, 0.2 to 0.75, or 0.25 to 0.75.

29. (canceled)

30. The method of claim 27, wherein the porous material is a membrane.

31. The method of claim 27, wherein the stamp comprises a roll or a plate and applying the stamp to the layer of porous material comprises a roll-to-roll process or a roll-to-plate process.

32. The method of claim 27, further comprising:
applying a second stamp to a second side of the layer of porous material, the second stamp having a second patterned outer surface that corresponds to a negative of a second pattern comprising a plurality of raised structures.

33. The method of claim 27, further comprising:
laminating the layer of porous material comprising a pattern of raised structures on the surface of the layer onto a second layer of porous material comprising a second pattern of raised structures on the surface of the second layer, resulting in a material comprising a pattern of raised structures on both major surfaces of the material.

34-36. (canceled)
